(19) United States
(12) Patent Application Publication
(10) Pub. No.: US 2011/0209167 A1
(43) Pub. Date: Aug. 25, 2011

(54) PROGRAM GUIDE DISTRIBUTION APPARATUS, PROGRAM TRANSMISSION APPARATUS, PROGRAM GUIDE RECEPTION TERMINAL, PROGRAM GUIDE TRANSMISSION/RECEPTION SYSTEM, PROGRAM GUIDE DISTRIBUTION METHOD, PROGRAM GUIDE RECEPTION METHOD, PROGRAM, AND RECORDING MEDIUM

(76) Inventors: Yoshiki YAMAMOTO, Osaka (JP); Kazutaka Nishio, Osaka (JP)

(21) Appl. No.: 13/026,681

(22) Filed: Feb. 14, 2011

(30) Foreign Application Priority Data
Feb. 19, 2010 (JP) 2010-035413

(51) Int. Cl. H04N 5/445; H04H 60/33

(52) U.S. Cl. 725/9; 725/40

(57) ABSTRACT

Provided is a program guide distribution apparatus in which the user does not particularly have to consciously perform searching, and the user can naturally recognize a forgot-to-view program in a daily act of viewing TV broadcast or TV guide. The program guide distribution apparatus includes: a related program decision unit that compares distributable programs which were broadcasted and which can be distributed, with programs which exist in a program guide of broadcast, and decides whether programs related to each other exist; a display information providing unit that provides a display indicative of the existence of the related program among the distributable programs to the program guide, when the related programs exists; and a program guide information distribution unit that distributes information of the program guide.

### BACKGROUND OF THE INVENTION

1. Field of the Invention

The present invention relates to a program guide distribution apparatus, a program transmission apparatus, a program guide reception terminal, a program guide transmission/reception system, etc.

2. Related Art of the Invention

In recent years, in order for a user to later view a program that the user forgot to view or record (forgot-to-view program), a mechanism (forgot-to-view program distribution), etc., in which a TV station or the like installs a server that stores broadcasted programs and distributes the programs to the user through the Internet or the like, are studied and attempted.

An example of a known method for receiving a program that a viewer forgot to view includes a system in which when the viewer designates a program that the viewer forgot to view, rebroadcast of the program is automatically searched, and the viewer receives the rebroadcast.

Hereinafter, a conventional reception method of a forgot-to-view program described, for example, in Japanese Patent Laid-Open No. 2004-200882 will be described.

FIG. 35 is a diagram showing an embodiment of a network configuration applicable to a conventional broadcast program recording designation system. As shown in FIG. 33, the rebroadcast program recording designation system comprises: a cell phone 810 of a registered user; a communication provider apparatus 820 that intermediates transfer of data between the cell phone 810 and Internet 860; a service center 830 managed by a service provider that performs services such as an individual broadcast program guide service (hereinafter, also called a broadcast program guide service provider); TV broadcasting stations 840 (a plurality of); a home 850 of the registered user comprising a recording apparatus 851, a TV receiver 852, etc.; and the Internet 860 that connects the cell phone 810, the communication provider apparatus 820, the service center 830, the home 850 of the registered user, etc.

The communication provider apparatus 820 comprises a base station 821 and a mobile communication control station 822.

The provider of services, such as a broadcast program guide service, obtains program guide data of each channel from the plurality of TV broadcasting stations 840 and periodically, or on an as needed basis, registers the program guide data in a database 832 of the service center 830.

The registered user activates the cell phone 810 to connect the cell phone 810 with a broadcast program guide service server 831 of the service center 830 through the communication provider apparatus 820 and the Internet 860. The registered user then selects a “Rebroadcast Program Recording Instruction” menu in a selection menu displayed on the screen of the cell phone 810 just after the connection and selects the date and channel that the forgot-to-view program is broadcasted.

If the user designates a forgot-to-view program from a plurality of past programs of the designated date and designated channel displayed on the cell phone 810, the cell phone (cell phone of rebroadcast program designation request source) 810 transmits identification information of the designated forgot-to-view program to the service center 830 through the communication provider apparatus 820 and the Internet 860. The method of designation is an example, and a program name may be directly designated.

If the identification information of the forgot-to-view program is received from the cell phone 810, the broadcast program guide service server 831 of the service center 830 searches the program guide data registered in the database 832, and if there is a rebroadcast program, transmits the program information to the cell phone 810 of the rebroadcast program recording request source. An example of the search method of rebroadcast program data includes a method of searching program databases of TV broadcasting stations or program databases provided from the TV broadcasting stations. Alternatively, rebroadcasting date/time information may be attached to the program information. When one program of cable TV, etc., is repeatedly broadcasted for a number of times, a comparison chart of program name and broadcasting date/time is often prepared.

The cell phone 810 of the rebroadcast program recording request source displays the received rebroadcast program information, and when the user performs a recording instruction operation, transmits a recording instruction to the broadcast program guide service server 831.

As a result, the broadcast program guide service server 831 transmits a recording reservation setting instruction including the rebroadcast program information (such as broadcasting start time and channel information of the rebroadcast program) to the recording apparatus 851 of the user of the cell phone 810 of the rebroadcast program recording request source through the Internet 860.

When the broadcasting start time comes, the recording apparatus 851 of the user of the cell phone 810 of the rebroadcast program reservation request source receives a rebroadcast program to be broadcasted from the TV broadcasting station 840 of the reserved channel and records the rebroadcast program in an installed recording medium.

The user may notice and view a forgot-to-view program. Furthermore, in a pay-per-view system in which the user pays viewing fees for the amount of viewing, there is a method of displaying a reminder on a local two-way TV program guide indicating that the user has missed viewing a pay-per-view program when there is a program that the user forgot to view (National Publication International Patent Application No. 2002-521874).

### SUMMARY OF THE INVENTION

However, as described, the rebroadcast of the program that the user has forgot to view is searched upon the designation by the user in the conventional viewing method of forgot-to-view program of Japanese Patent Laid-Open No. 2004-200882. Therefore, there is a problem that the program remains not viewed forever unless the user consciously searches the program.

Furthermore, just the fact that the user has missed viewing the program is informed in the conventional reminder system of National Publication International Patent Application No. 2002-521874. There is no further refinement for the user, and there is a problem that the user forgets to view the program for a long time.

The present invention solves the problems in the conventional viewing techniques, and an object of the present invention is to provide a program guide distribution apparatus, a program transmission apparatus, a program guide reception terminal, a program guide transmission/reception system, etc., in which the user does not particularly have to consciously perform searching, and the user can naturally recognize a forgot-to-view program in a daily act of viewing TV broadcast or TV guide.

To solve the above-described problems,

the 1^{st} aspect of the present invention is a program guide distribution apparatus comprising:

a related program decision unit that compares distributable programs which were broadcasted and which can be distributed, with programs which exist in a program guide of broadcast, and decides whether programs related to each other exist;

a display information providing unit that provides a display indicative of the existence of the related program among the distributable programs to the program guide, when the related programs exist; and

a program guide information distribution unit that distributes information of the program guide.

The 2^{nd} aspect of the present invention is a program distribution apparatus comprising:

the program guide distribution apparatus according to the 1^{st} aspect of the present invention;

a broadcast program distribution unit that distributes a program to be broadcasted; and

a program guide multiplexing unit that multiplexes the program guide information with the program to be broadcasted, wherein

the broadcast program distribution unit also serves as the program guide information distribution unit.

The 3^{rd} aspect of the present invention is a program distribution apparatus comprising:

the program guide distribution apparatus according to the 1^{st} aspect of the present invention; and

a broadcast program distribution unit that distributes a program to be broadcasted, wherein

the program guide information distribution unit distributes the information of the program guide and the information of the program guide is distributed separately from the program to be broadcasted.

The 4^{th} aspect of the present invention is a program guide reception terminal comprising:

a program guide information reception unit that receives information of a program guide which is generated by a program guide distribution apparatus comparing distributable programs which were broadcasted and which can be distributed, with programs which exist in a program guide of broadcast, and deciding whether programs related to each other exist, and providing a display indicative of the existence of the related program among the distributable programs to the program guide when the related programs exist; and

a display information control unit that controls the display indicative of the existence of the related program among the distributable programs provided to the program guide, wherein

the display information control unit changes or deletes the display indicative of the existence of the related program among the distributable programs in the case that the distributable program is already viewed.

The 5^{th} aspect of the present invention is the program guide reception terminal according to the 4^{th} aspect of the present invention, further comprising

a history creation unit that creates a viewing history based on viewed programs; and

a preference information extraction unit that extracts preference information of a viewer from the viewing history, wherein

the display information control unit changes or deletes the display indicative of the existence of the related program among the distributable programs, when the related program among the distributable programs and the preference information do not match.

The 6^{th} aspect of the present invention is the program guide reception terminal according to the 5^{th} aspect of the present invention, wherein

the history creation unit creates the viewing history based on a viewing status of viewing through broadcast or network.

The 7^{th} aspect of the present invention is the program guide reception terminal according to the 6^{th} aspect of the present invention, wherein

the preference information extraction unit extracts the preference information of the viewer from the viewing history created based also on a viewing status of the related program among the distributable programs.

The 8^{th} aspect of the present invention is a program guide transmission/reception system comprising:

a program guide distribution apparatus comprising: a related program decision unit that compares distributable programs which were broadcasted and which can be distributed, with programs which exist in a program guide of broadcast, and decides whether programs related to each other exist; a display information providing unit that provides a display indicative of the existence of the related program among the distributable programs to the program guide, when the related programs exist; and a program guide information distribution unit that distributes information of the program guide; and

a program guide reception terminal comprising: a program guide information reception unit that receives the information of the program guide; and a display information control unit that controls the display indicative of the existence of the related program among the distributable programs provided to the program guide, wherein the display information control unit changes or deletes the display indicative of the existence of the related program among the distributable programs in the case that the distributable program is already viewed.

The 9^{th} aspect of the present invention is the program guide distribution apparatus according to the 1^{st} aspect of the present invention, wherein

the related program is a program continuous with the distributable program, a program with the same cast as the distributable program, or a program of the same genre as the distributable program.

The 10^{th} aspect of the present invention is the program guide distribution apparatus according to the 1^{st} aspect of the present invention, wherein

the display information providing unit provides the display indicative of the existence of the related program among the distributable programs to a frame of one of a plurality of program fields of the channel to which the related program belongs.

The 11^{th} aspect of the present invention is the program guide distribution apparatus according to the 1^{st} aspect of the present invention, wherein

the display information providing unit provides the display indicative of the existence of the related program among the distributable programs to a time display field.

The 12^{th} aspect of the present invention is a program guide distribution method comprising:

a related program decision step of comparing distributable programs which were broadcasted and which can be distributed, with programs which exist in a program guide of broadcast, and deciding whether programs related to each other exist;

a display information providing step of providing a display indicative of the existence of the related program among the distributable programs to the program guide, when the related programs exist; and

a program guide information distribution step of distributing information of the program guide.

The 13^{th} aspect of the present invention is a program guide reception method comprising:

a program guide information reception step of receiving information of a program guide which is generated by a program guide distribution method comparing distributable programs which were broadcasted and which can be distributed, with programs which exist in a program guide of broadcast, and deciding whether programs related to each other exist, and providing a display indicative of the existence of the related program among the distributable programs to the program guide when the related programs exist; and

a display information control step of controlling the display indicative of the existence of the related program among the distributable programs provided to the program guide, wherein

the display related to the distributable program is changed or deleted in the display indicative of the existence of the related program among the distributable programs in the case that the distributable program is already viewed.

The 14^{th} aspect of the present invention is a non-transitory computer-readable medium having a program stored thereon for causing a computer to execute the program guide distribution method according to the 12^{th} aspect of the present invention.

The 15^{th} aspect of the present invention is a non-transitory computer-readable medium having a program stored thereon for causing a computer to execute the program guide reception method according to the 13^{th} aspect of the present invention.

According to the present invention, a program guide distribution apparatus, a program transmission apparatus, a program guide reception terminal, a program guide transmission/reception system, etc., can be provided, in which the user does not particularly have to consciously perform searching, and the user can naturally recognize a forgot-to-view program in a daily act of viewing TV broadcast or TV guide.

### BRIEF DESCRIPTION OF THE DRAWINGS

FIG. 1 is a diagram showing a configuration of a program transmission/reception system according to a first embodiment of the present invention;

FIG. 2 is a diagram showing a flow of a “Missed-to-view” mark providing process according to the first embodiment of the present invention;

FIGS. 3(A) and 3(B) are diagrams showing examples of EPGs according to the first embodiment of the present invention;

FIG. 4 is a diagram showing a flow of a history management process according to the first embodiment of the present invention;

FIG. 5 is a diagram showing a flow of an EPG display preparation process according to the first embodiment of the present invention;

FIGS. 6(A) and 6(B) are diagrams showing examples of the EPGs according to the first embodiment of the present invention;

FIG. 7 is a diagram showing a configuration of the program transmission/reception system according to a second embodiment of the present invention;

FIG. 8 is a diagram showing a flow of the “Missed-to-view” mark providing process according to the second embodiment of the present invention;

FIG. 9 is a diagram showing a configuration of the program transmission/reception system according to a third embodiment of the present invention;

FIG. 10(A) is a diagram showing a flow of a broadcast program reception process according to the third embodiment of the present invention;

FIG. 10(B) is a diagram showing a flow of the history management process according to the third embodiment of the present invention;

FIG. 10(C) is a diagram showing a flow of a preference extraction process according to the third embodiment of the present invention;

FIG. 11 is a diagram showing a flow of a “Forgot-to-view Program” information reception process according to the third embodiment of the present invention;

FIGS. 12(A) and 12(B) are diagrams showing examples of the EPGs according to the third embodiment of the present invention;

FIG. 13 is a diagram showing a flow of the broadcast program reception process according to the third embodiment of the present invention;

FIGS. 14(A) and 14(B) are diagrams showing examples of the EPGs according to the third embodiment of the present invention;

FIGS. 15(A) and 15(B) are diagrams showing another example of the EPG according to the third embodiment of the present invention;

FIG. 16 is a diagram showing a configuration of another example of the program transmission/reception system according to the third embodiment of the present invention;

FIG. 17 is a diagram showing a configuration of another example of the program transmission/reception system according to the third embodiment of the present invention;

FIG. 18 is a diagram showing a configuration of the program transmission/reception system according to a fourth embodiment of the present invention;

FIGS. 19(A) and 19(B) are diagrams showing examples of the EPGs according to the fourth embodiment of the present invention;

FIG. 20 is a diagram showing another example of the EPG according to the fourth embodiment of the present invention;

FIG. 21 is a diagram showing another example of the EPG according to the fourth embodiment of the present invention;

FIG. 22 is a diagram showing a configuration of the program transmission/reception system according to a fifth embodiment of the present invention;

FIG. 23 is a diagram showing a flow of the “Forgot-to-view Program” information reception process according to the fifth embodiment of the present invention;

FIG. 24 is a diagram showing a configuration of another example of the program transmission/reception system according to the third embodiment of the present invention;

FIG. 25 is a diagram showing another example of the flow of the history management process according to the third embodiment of the present invention;

FIG. 26 is a diagram showing another example of the flow of the “Forgot-to-view Program” information reception process according to the third embodiment of the present invention;

FIGS. 27(A) and 27(B) are diagrams showing another example of the EPG according the embodiments of the present invention;

FIG. 28(A) is a diagram showing another example of the EPG according to the embodiments of the present invention;

FIG. 28(B) is a diagram showing another example of the EPG according to the embodiments of the present invention;

FIG. 28(C) is a diagram showing another example of the EPG according to the embodiments of the present invention;

FIGS. 29(A) and 29(B) are diagrams showing another example of the EPG according to the embodiments of the present invention;

FIG. 30 is a diagram showing a configuration of another example of the program transmission/reception system according to the third embodiment of the present invention;

FIG. 31 is a diagram showing a configuration of another example of the program transmission/reception system according to the third embodiment of the present invention;

FIGS. 32(A) and 32(B) are diagrams showing another example of providing a forgot-to-view mark according to the embodiments of the present invention;

FIG. 33 is a diagram showing a configuration of another example of the program transmission/reception system according to the first embodiment of the present invention;

FIG. 34 is a diagram showing a configuration of another example of the program transmission/reception system according to the second embodiment of the present invention; and

FIG. 35 is a diagram showing a conventional program reception system.

### DESCRIPTION OF SYMBOLS

1, 60, 100, 1000, 1100 broadcast stations
3, 300 public line networks
4, 62, 200, 2000, 2100, 2200 program reception apparatuses
10, 63, 110, 1110 normal broadcast program system units
11, 111 broadcast program distribution units
12, 112 program guide information management units
13 missed-to-view information providing unit
14, 114 program guide multiplexing units
15, 115, 175, 1015 related program decision units
16, 116, 154, 176, 1016 related program identification units
20, 120 missed-to-view program system units
22 distributable program information extraction unit
23, 123 storage units
25 missed-to-view program distribution unit
26 distributable program information management unit
30, 130 reception units
31, 131, 180 program guide information extraction units
40, 140 communication units
41 missed-to-view program reception unit
42 history management unit
43 preference information extraction unit
44, 144 program guide display control units
45 missed-to-view information control unit
46, 146 operational input reception units
47, 147 display screens
147a another screen
49, 153 preference information storage units
51, 151 history creation units
52, 152 history storage units
61, 1170 program guide distribution apparatuses
64 missed-to-view program system unit
65, 174 program guide distribution units
66 distributable program information reception unit
67, 172 program guide information reception units
68 program guide information extraction unit
113 forgot-to-view information providing unit
117 forgot-to-view program time management unit
120 forgot-to-view program system unit
122 forgot-to-view program information extraction unit
124 search unit
125 forgot-to-view program distribution unit
126, 177 forgot-to-view program information management units
127, 148 forgot-to-view program determination units
132 program guide information management unit
141 forgot-to-view program reception unit
142 history management unit
143 preference information extraction unit
145 forgot-to-view information control unit
149 want-to-view program identification unit
150 want-to-view program search unit
171 forgot-to-view program information reception unit
173 forgot-to-view information providing unit
190 not-yet-view program extraction unit
191 replay instruction unit
192 video composite display control unit
400, 410, 1100, 1105, 1200, 1210, 1220, 1300, 3000, 3001, 3004, 3007, 500, 510, 600, 610, 700, 710, 800, 810 EPGs
401, 411, 501, 511, 601, 611, 701, 711, 801, 811, 1101, 1115, 1201, 1211, 1221, 1301, 1311, 1601 “Forgot-to-view” marks
810 cell phone
820 communication provider apparatus
821 base station
822 mobile communication control station
830 service center
831 broadcast program guide service server
832 database
840 TV broadcasting station
850 home
851 recording apparatus
852 TV receiver
860 Internet
3002, 3005, 3006 “Missed-to-view” marks

### PREFERRED EMBODIMENTS OF THE INVENTION

Hereinafter, embodiments of the present invention will be described with reference to the drawings.

### First Embodiment

A program transmission/reception system of a first embodiment as an example of a program guide transmission/reception system of the present invention will be described below with reference to the drawings.

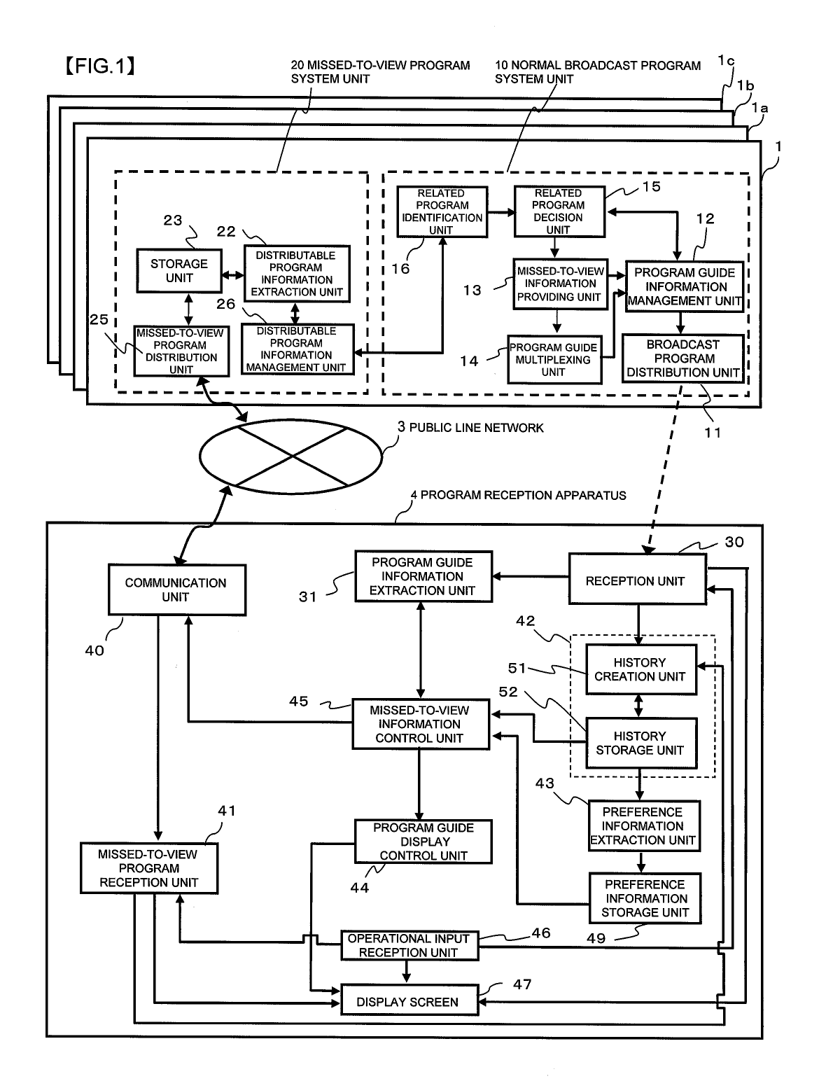

FIG. 1 is a diagram showing a configuration of the program transmission/reception system according to the first embodiment of the present invention.

As shown in FIG. 1, the program transmission/reception system according to the present first embodiment comprises a broadcast station 1 that broadcasts a program and a program reception apparatus 4 possessed by the user to receive a broadcasted program.

A summary of the program transmission/reception system according to the present first embodiment will be described. The broadcast station 1 commonly distributes an electric program guide (hereinafter, referred to as “EPG”) provided with “Missed-to-view” marks to all households in a coverage area. For each household, the program reception apparatus 4 executes processes, such as changing a “Missed-to-view” mark and deleting an unnecessary “Missed-to-view” mark from the received EPG, when the EPG is received based on a viewing history, a preference history, etc. The program reception apparatus 4 presents the processed EPG to the user.

The broadcast station 1 of the present first embodiment comprises a normal broadcast program system unit 10 and a missed-to-view program system unit 20. Although the normal broadcast denotes digital terrestrial broadcast, BS digital broadcast, etc., the broadcast is not particularly limited as long as the EPG can be generated for the broadcast. The broadcast station 1 corresponds to an example of a program distribution apparatus of the present invention.

First, a configuration of the broadcast station 1 corresponds to an example of the program guide distribution apparatus and a program transmission apparatus of the present invention will be described.

The normal broadcast program system unit 10 comprises a broadcast program distribution unit 11 that broadcasts programs, a program guide information management unit 12 that generates an EPG, and a program guide multiplexing unit 14 that multiplexes the EPG with the broadcast programs. The normal broadcast program system unit 10 further comprises a related program identification unit 16 that identifies a “Related Program” related to a distributable program (hereinafter, called “Distributable Program”) stored in a storage unit 23 described below, a related program decision unit 15 that decides whether the identified “Related Program” is in the EPG, and a missed-to-view information providing unit 13 that provides a “Missed-to-view” mark to a program field of the “Related Program” if the “Related Program” is in the EPG.

The missed-to-view program system unit 20 comprises a storage unit 23 that stores an already broadcasted program, a distributable program information extraction unit 22 that extracts information of the “Distributable Program” stored in the storage unit 23, a distributable program information management unit 26 that manages the extracted information of the distributable program and that transmits the information to the normal broadcast program system unit 10, and a missed-to-view program distribution unit 25 that distributes a “Missed-to-view Program” to the program reception apparatus 4 in response to a request from the program reception apparatus 4. An example of the information related to the “Distributable Program” is program name, broadcast date/time, series program, genre, cast, replay time, etc.

A configuration of the program reception apparatus 4 corresponding to an example of a program guide reception terminal of the present invention will be described.

The program reception apparatus 4 according to the present first embodiment comprises a reception unit 30 that receives broadcast from the broadcast program distribution unit 11 of the broadcast station 1 and a program guide information extraction unit 31 that extracts information related to the EPG from the information received by the reception unit 30.

The program reception apparatus 4 further comprises a history management unit 42 that creates a viewing history based on programs that the user has selected channels to receive and that manages the tendency and history of viewing. The history management unit 42 comprises a history creation unit 51 that creates a viewing history based on predetermined past EPG information and the received programs and a history storage unit 52 that stores the created history. The program reception apparatus 4 further comprises a preference information extraction unit 43 that extracts user preference information based on the viewing history stored in the history storage unit 52 and a preference information storage unit 49 that stores the extracted preference information. The program reception apparatus 4 further comprises a missed-to-view information control unit 45 that controls the missed-to-view information, such as by changing or deleting a “Missed-to-view” mark provided to the extracted EPG, based on the viewing history, the preference information, etc. The viewing history is, for example, a reception history. The reception history is, for example, selecting a channel which broadcast a program in the time when the program is broadcasted.

The program reception apparatus 4 further comprises a communication unit 40 that is connected to the missed-to-view program system unit 20 of the broadcast station 1 through a public line network 3 such as the Internet.

The program reception apparatus 4 further comprises an operational input reception unit 46 that receives an operational input from the user and a missed-to-view program reception unit 41 that receives a program that the user missed to view from the missed-to-view program system unit 20 through the communication unit 40 when a “Missed-to-view” mark is selected by an operational input. Various methods can be used by the user to input an operation, such as a use of a remote control, a touch panel, etc. to directly select a menu from the screen and an operation of a switch, etc. of the TV main body.

A display screen 47 displays the broadcast received by the reception unit 30 or information related to the broadcast, the “Missed-to-view Program” received by the missed-to-view program reception unit 41 or information related to the “Missed-to-view Program”, the EPG information, etc. An example of the display screen includes a liquid crystal display. An example of the program reception apparatus 4 includes a TV. The program reception apparatus 4 further comprises a program guide display control unit 44 that controls display of the EPG on the display screen 47.

The missed-to-view program distribution unit 25 of the broadcast station 1 and the communication unit 40 of the program reception apparatus 4 are connected through the public line network 3.

An example of a display information providing unit of the present invention corresponds to the missed-to-view information providing unit 13 of the present first embodiment. An example of a program guide information distribution unit that also serves as a broadcast program distribution unit of the present invention corresponds to the broadcast program distribution unit 11 of the present first embodiment. An example of a display information control unit of the present invention corresponds to the missed-to-view information control unit 45 of the present first embodiment, and an example of a program guide information reception unit of the present invention corresponds to the reception unit 30 of the present first embodiment.

An operation of the program transmission/reception system according to the present first embodiment will be described with reference to the drawings, and examples of a program guide transmission method and a program guide reception method of the present invention will be described at the same time.

First, a process of providing a “Missed-to-view” mark on the EPG in the broadcast station 1 will be described.

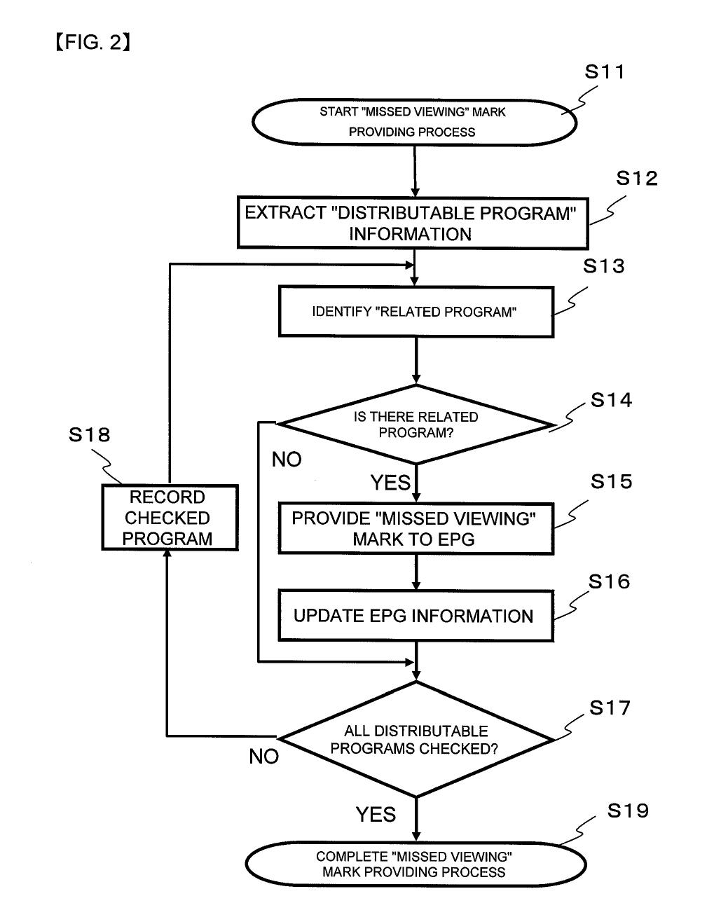

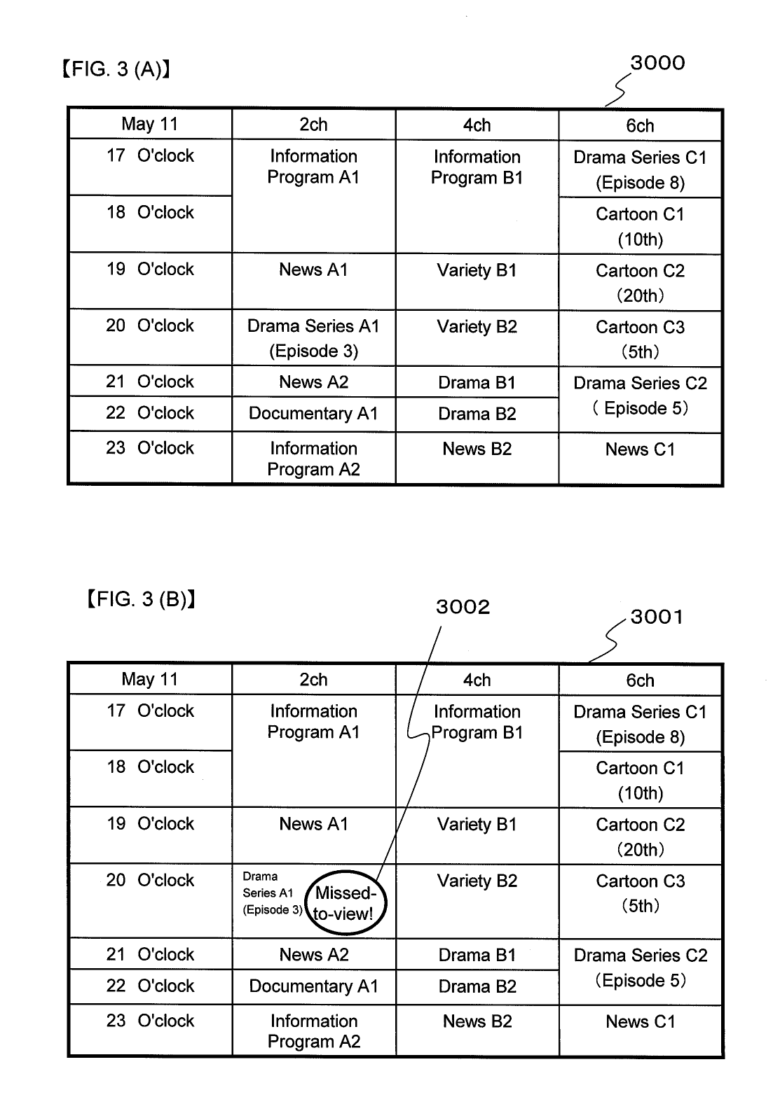

FIG. 2 is a flow chart for explaining a process until the “Missed-to-view” mark is provided to the EPG in the broadcast station 1. FIGS. 3(A) and 3(B) are diagrams showing examples of EPGs. Steps will be abbreviated as “S” in the drawings.

When a “Missed-to-view” mark providing process starts in step S11, the distributable program information extraction unit 22 of the broadcast station 1 extracts information related to the “Distributable Program” stored in the storage unit 23 in step S12. Specifically, if first and second episodes of a drama series A1 are stored in the storage unit 23 as the “Distributable Programs”, information related to the first and second episodes of the drama series A1 is extracted. If programs other than the drama series A1 are stored in the storage unit 23, information related to all programs is extracted.

In step S13, the related program identification unit 16 identifies “Related Programs” related to the “Distributable Programs” from the extracted information based on a predetermined rule.

Specifically, if the first and second episodes of the drama series A1 are stored in the storage unit 23 as the “Distributable Programs”, the “Related Programs” are identified as a third episode, a fourth episode, . . . following the second episode of the drama series A1. In this case, the predetermined rule is a rule “if one of the episodes of a drama series is stored as a “Distributable Program”, all programs of the drama series are identified as “Related Programs””.

When the “Related Program” is identified, the related program decision unit 15 checks in step S14 whether the “Related Program” is in the programs of the EPG of the next two weeks managed by the program guide information management unit 12. Step S14 corresponds to an example of a related program decision step of the present invention.

If the “Related Program” (the third episode of the drama series A1 here) exists in the EPG in step S14, the existence is transmitted to the missed-to-view information providing unit 13. The missed-to-view information providing unit 13 provides the “Missed-to-view” mark to the frame of the third episode of the drama series A1 of the EPG as the “Related Program” in step S15 and updates the EPG information in step S16. Step S15 corresponds to an example of a display information providing step of the present invention.

An example of the related programs according to the present invention corresponds to a program (for example the third episode of the drama series A1) which is related to “Distributable Programs” and which exists in EPG, and a program (for example the first episode, the second episode of the drama series A1) which is related to programs of EPG and which exists among the “Distributable Programs”.

FIG. 3(A) is a diagram showing an EPG 3000. FIG. 3(B) is a diagram showing an EPG 3001 provided with a “Missed-to-view” mark 3002. An example of a program guide of the present invention corresponds to the EPG 3000. A example of a period which The EPG 3000 shown in FIG. 3(A) can display is a period of two weeks from the current time zone. The time zone is for period of time between a certain time and a certain time. The current time zone is, for example, a time zone of an hourly basis, and if the current time is in a time zone from 17 o'clock to 18 o'clock (for example, 17:40) of May 11, the EPG is a program guide of a period of two weeks from 17 o'clock.

The process then proceeds to step S17, and the presence of another “Distributable Program” is checked.

Meanwhile, in FIG. 2, if the “Related Programs” (the third episode, the fourth episode, . . . of the drama series A1 here) are not in the EPG in step S14, the process proceeds to step S17. It is more preferable to periodically check the “Distributable Programs” that are once checked, because the programs may be in the EPGs distributed later.

In step S17, the distributable program information management unit 26 determines whether there is another “Distributable Program” in the storage unit 23. If there is another “Distributable Program”, the process proceeds to step S18, and the distributable program information management unit 26 records the “Distributable Program” for which the presence of the “Related Program” is checked. The process returns to step S13, and the “Related Programs” of the other “Distributable Program” are identified. If a first episode of an information program A1 that describes biology of different animals, etc., every week is stored as the “Distributable Program”, a second episode, a third episode, . . . after the first episode of the information program A1 are identified as the “Related Programs”. If a second episode of an information program A2 that describes different types of job is stored, a third episode, a fourth episode, . . . after the second episode of the information program A2 are identified as the “Related Programs”. In this case, the predetermined rule is a rule “if one of the episodes of an information program is stored as a “Distributable Program”, all programs of the information program are identified as “Related Programs””.

Whether the “Related Programs” (the second episode, the third episode, . . . of the information program A1 here) exist in the EPG is determined. If the “Related Programs” exist, “Missed-to-view” marks are provided to the EPG, and the EPG is updated (steps S14 to 16). On the other hand, if the “Related Programs” do not exist, whether there is another “Distributable Program” is determined (step S17).

If the process for all “Distributable Programs” is completed, the missed-to-view mark providing process completes in step S19.

When the EPG provided with the “Missed-to-view” marks is transmitted, the program guide multiplexing unit 14 multiplexes the EPG with the broadcast programs, and the broadcast program distribution unit 11 transmits the EPG to the program reception apparatus 4 in the coverage area. The transmission process of the EPG corresponds to an example of a program guide information distribution step of the present invention.

The program guide is currently generated and transmitted for each station in the digital terrestrial broadcast. Therefore, if other broadcast stations 1a to 1c execute the same process as the broadcast station 1, the “Missed-to-view” marks can be provided to EPGs of all stations.

Processes of the program reception apparatus 4 according to the first embodiment of the present invention will be described.

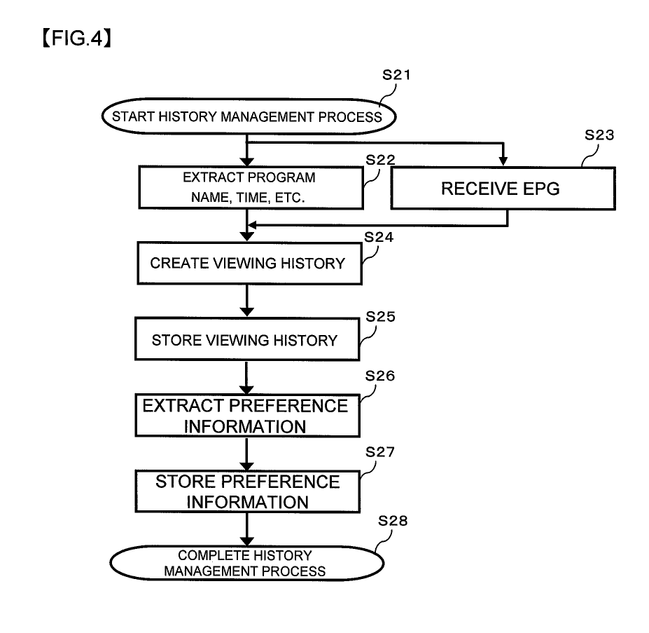

First, among the processes executed by the program reception apparatus 4, a history management process executed on a regular basis when a broadcast program is received will be described. FIG. 4 is a diagram showing a flow of the history management process as an operation executed on a regular basis when the program reception apparatus 4 receives a broadcast program according to the first embodiment of the present invention.

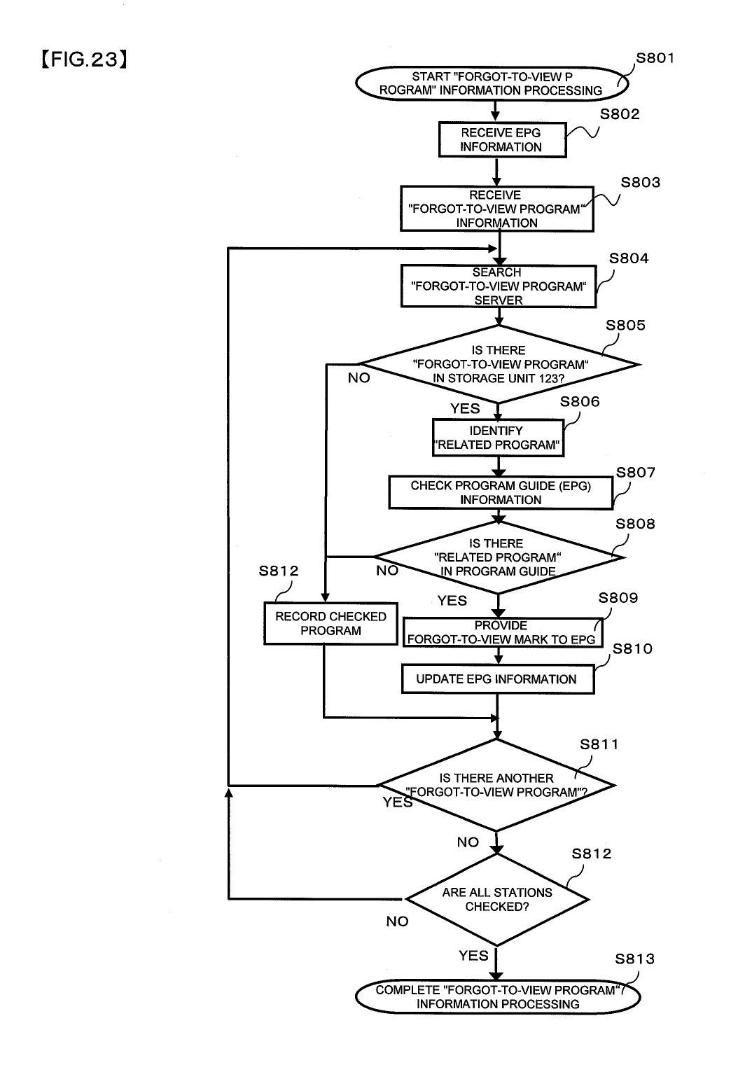

As shown in FIG. 4, the history management process starts when the user receives a broadcast program through the reception unit 30 in step S21. After the reception of the broadcast program, the history creation unit 51 extracts the received program name, time, etc., in step S22. Meanwhile, as shown in FIG. 23, the received EPG multiplexed with the broadcast program is also transmitted to the history creation unit 51. In step S24, the history creation unit 51 creates a viewing history of names, times, etc. of the programs viewed in a predetermined past period from the EPG information and the extracted program names, times, etc. In step S25, the viewing history, the EPG information, etc. are stored in the history storage unit 52.

Subsequently, in step S26, the preference information extraction unit 43 extracts “Preference Information” of the user based on the viewing history stored in the history storage unit 52 and based on a predetermined rule. For example, if the number of times of viewing the field of the information program is greater than that of the drama series or the news, the “Preference Information” indicating that the user prefers the information program is extracted. In this case, the predetermined rule is a rule “if the number of times of viewing programs of a specific field is significantly greater than the numbers of times of viewing programs of other fields (for example, more than three times) statistically in the past viewing history, the “Preference Information” is identified by determining that the user prefers the specific field”.

The extracted preference information is stored in the preference information storage unit 49 in step S27, and the history management process completes in step S28.

In this way, the viewing history is created, and the preference information is identified on a regular basis. Although the history management process starts when the broadcast programs are received in the present embodiment, the reception of the broadcast program may not be trigger. The broadcast programs may be periodically received, and the received broadcast programs may be collectively processed. Furthermore, the creation of history and the identification of preference information may not be continuously performed as shown in FIG. 4, but may be separately performed. Although described in detail later, the reception of the broadcast programs also includes reception of “Missed-to-view Programs”.

A flow of an EPG display preparation process of the program reception apparatus 4 according to the first embodiment of the present invention after the reception of the EPG will be described.

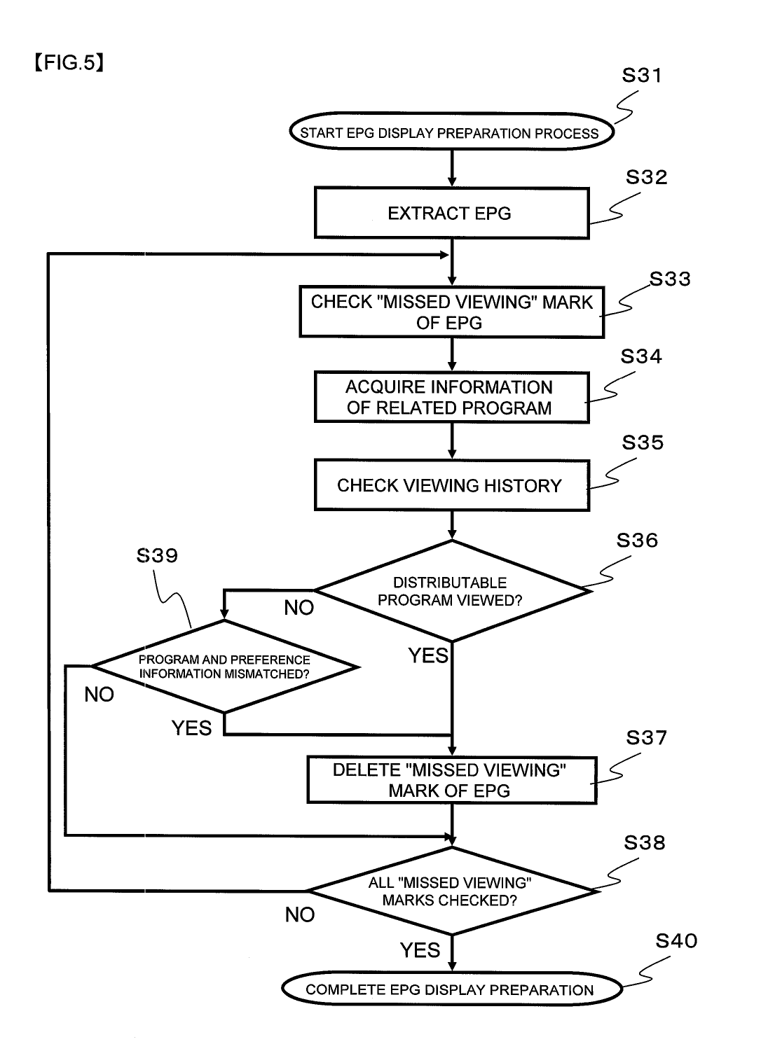

FIG. 5 is a diagram showing a flow of the EPG display preparation process of the program reception apparatus 4 after the reception of the EPG.

In step S31 of FIG. 5, the EPG display preparation process starts when the reception unit 30 of the program reception apparatus 4 receives a broadcast program. In step S32, the program guide information extraction unit 31 extracts the EPG from the reception unit 30. The extracted EPG is transmitted to the missed-to-view information control unit 45. The process of receiving the EPG corresponds to an example of a program guide information reception step of the present invention.

The missed-to-view information control unit 45 checks the “Missed-to-view” marks of the received EPG in step S33 and receives information of the “Related Programs” provided with the “Missed-to-view” marks in step S34. The missed-to-view information control unit 45 may determine the reception of the information of the “Related Programs” based on the program information of the EPG or may receive the information from the missed-to-view program system unit 20 through the communication unit 40. The method of receiving the information is not particularly limited.

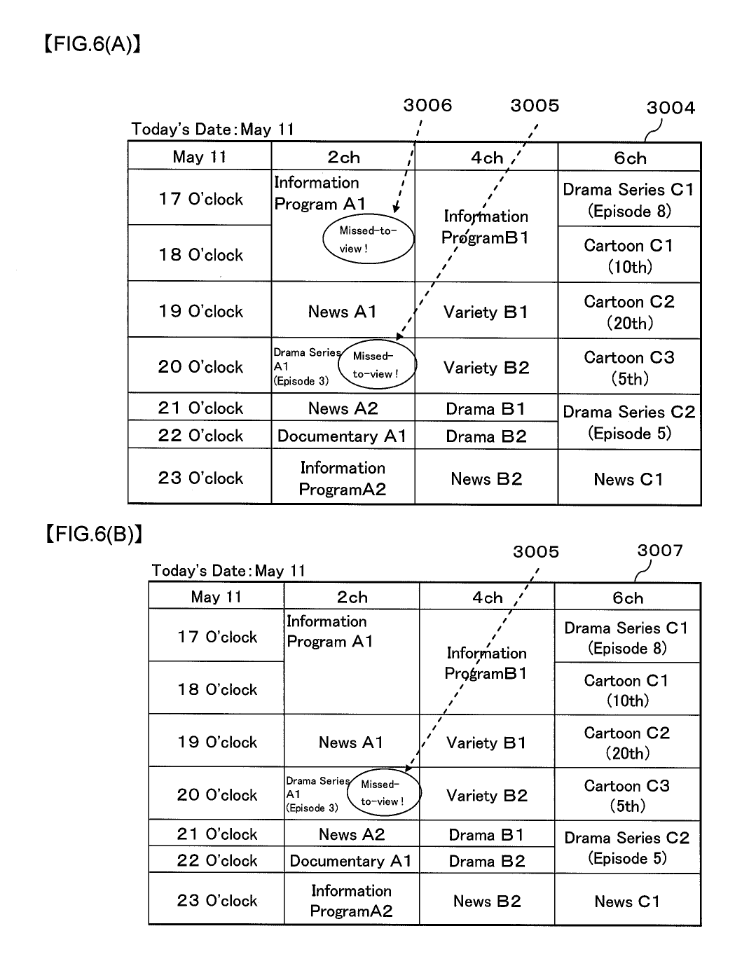

Specifically, as described, the third and subsequent episodes of the drama series A1 are defined as the “Related Programs”. Therefore, if the drama series A1 is broadcasted every week and information of two weeks is described in the EPG, the third and fourth episodes of the drama series A1 are described in the EPG, and the “Missed-to-view” marks are provided to the third and fourth episodes. FIG. 6(A) shows an EPG 3004 in which a “Missed-to-view” mark 3005 is provided to the frame of the third episode of the drama series A1. The programs from 20 o'clock to 21 o'clock including the next episode (fourth episode) of the drama series A1 would be checked by scrolling the screen. In the EPG 3004, a “Missed-to-view” mark 3006 is provided to the information program A1.

After the reception of the information of the “Related Programs”, the missed-to-view program control unit 45 checks the viewing history received from the history management unit 42 in step S35. In step S36, if the “Distributable Program” corresponding to the “Missed-to-view” mark is already viewed, the display of the “Missed-to-view” mark is deleted because the possibility of the user viewing the “Distributable Program” again is low. Specifically, if the user of the program reception apparatus 4 has already viewed the first and second episodes of the drama series A1 when the broadcast station 1 can distribute the first and second episodes of the drama series A1 and provides “Missed-to-view” marks to the third and fourth episodes of the drama series A1 in the EPG, the “Missed-to-view” mark provided to the third episode of the drama series A1 is deleted because the possibility of the user viewing the first and second episodes of the drama series A1 again is low.

If the “Distributable Programs” (the first and second episodes of the drama series A1) are not received in step S36, the missed-to-view information control unit 45 extracts the preference information from the preference information storage unit 49, and in step S39, checks whether the “Distributable Programs” and the preference of the user do not match. If the “Distributable Programs” and the preference of the user do not match, the missed-to-view information control unit 45 determines that the possibility of the user viewing the “Distributable Programs” is low. The process proceeds to step S37, and the “Missed-to-view” marks are deleted. Specifically, if the user has not viewed the first and second episodes of the drama series A1 and the preference of the user is, for example, “Information Program”, the “Distributable Programs” and the “Preference Information” of the user do not match. Therefore, the possibility of the user viewing the first and second episodes of the drama series A1 is low, and the “Missed-to-view” mark provided to the frame of the third episode is deleted.

On the other hand, if the preference of the user and the “Distributable Programs” match in step S36, the possibility that the user has actually missed viewing the programs is high, because the “Distributable Programs” are not viewed when the programs are broadcasted in normal broadcast, and the user prefers the programs. Therefore, it is determined that the possibility of the user viewing the “Distributable Programs” is high, and the “Missed-to-view” marks remain displayed.

In step S38, the missed-to-view information control unit 45 checks whether all “Missed-to-view” marks are checked in the same way. If all “Missed-to-view”marks are checked, the EPG display preparation process completes in step S40. On the other hand, if the checking of all “Missed-to-view” marks is not finished, the other “Missed-to-view” marks are checked in the same way. For example, the fourth episode of the drama series A1 is checked in the same way. The “Missed-to-view” mark 3006 is provided to the information program A1 as shown in FIG. 6(A), and the information program A1 is checked in the same way. Steps S36, S39, and S37 correspond to an example of a display information control step of the present invention. The fourth episode of the drama series A1 may be treated as the same series program as the third episode and may be processed at the same time. Instead of a simple “Missed-to-view” mark, a display “Missed-to-view, First Episode and Second Episode” may be provided as a mark provided to the EPG distributed by the broadcast station 1, and the program reception apparatus 4 may change the display to “Missed-to-view, Second Episode” if the user has viewed the first episode. If the user has viewed the “Distributable Program”, or if the “Distributable Program” and the preference do not match, a change can be made by altering the color of the “Missed-to-view” mark instead of deleting the “Missed-to-view” mark.

When the user selects to display the EPG, the operational input reception unit 46 receives an operational input from a remote control or an operation panel, and the program guide display control unit 44 displays the EPG on the display screen 47. The EPG 3004 shown in FIG. 6(A) is a diagram showing an example of a state in which an EPG is transmitted from the broadcast station 1. In the state, the “Missed-to-view” marks 3005 and 3006 are provided.

In the EPG 3004 shown in FIG. 6(A), the “Missed-to-view” mark 3005 is provided to the drama series A1 (third episode) of channel 2, and the “Missed-to-view” mark 3006 is provided to the information program A1. If the user has not viewed the drama series A1 and the information program A1 before May 11 and if the “Preference Information” of the user indicates drama series, the drama series A1 and the user preference information match. Therefore, the “Missed-to-view” mark 3005 remains displayed. On the other hand, the information program A1 and the user preference information do not match, and the “Missed-to-view” mark 3006 is deleted. An EPG 3007 in such a state is illustrated in FIG. 6(B).

In the EPG 3007 shown in FIG. 6(B), if the user presses, for example, a determination button of the remote control in the frame of the drama series A1, information of the third episode of the drama series A1 is usually displayed. If a specific button, such as a button for data broadcast reception, is pressed, the “Missed-to-view” mark 3005 is selected.

As the operational input reception unit 46 receives the selection instruction, the program reception apparatus 4 accesses the missed-to-view program system unit 20 through the public line network 3. The missed-to-view program system unit 20 transmits the first episode of the drama series A1 from the missed-to-view program distribution unit 25 to the program reception apparatus 4 through the public line network 3. When the missed-to-view program reception unit 41 receives the transmitted program through the communication unit 40, the program that the user has missed viewing is displayed on the display screen 47, and the user starts viewing the program.

After the reception of the program that the user has missed viewing, the missed-to-view information control unit 45 deletes the “Missed-to-view” mark 3005 of the EPG. The information related to the program received by the missed-to-view program reception unit 41 is also transmitted to the history creation unit 51, and the viewing history is created in consideration of the information related to the program and is stored in the history storage unit 52. Therefore, the viewing history of the program that the user has missed viewing is also taken into consideration when the user preference information is extracted. Since the user has missed viewing the first and second episodes of the drama series A1 in the present first embodiment, the “Missed-to-view” mark 3005 is deleted after the reception of the first and second episodes. Instead of a simple “Missed-to-view” mark, “Missed-to-view, First and Second Episodes” may be displayed, and the display may be changed to “Missed-to-view, Second Episode” after the user views the first episode.

As described, in the present first embodiment, if programs related to programs that can be distributed by the broadcast station 1 are in the EPG, “Missed-to-view” marks are provided to the EPG to notify a plurality of users of the existence of the distributable program. However, some users may have already viewed the programs, or the programs and the preference may not match. Therefore, the program reception apparatus 4 on the user side deletes unnecessary “Missed-to-view” marks among the “Missed-to-view” marks provided by the broadcast station 1, and as a result, a program that the user likely has actually missed viewing (“Missed-to-view Program”) can be displayed on the EPG. The program viewing terminal can replay the missed-to-view program acquired from the missed-to-view program system unit stored in the broadcast station.

In this way, for example, when the user wants to view a missed episode of a drama series before the start of the next episode, the user can well recognize the existence of the “Missed Program” before the start of the next episode triggered by the next episode (related program) just by viewing the EPG frequently used upon viewing TV or upon recording, even if the user forgets the existence of the program missed to view. In this way, missing of continuous programs is also taken into consideration, and the apparatus is significantly user-friendly.

Although the program reception apparatus 4 identifies the preference information on a regular basis as described above, the arrangement is not limited to this. Instead of the identification on a regular basis, the broadcast station 1 may transmit a signal for transmitting the EPG to the program reception apparatus 4, and the program reception apparatus 4 may identify the preference information.

Although the display screen for displaying the EPG and the display screen of the programs to be broadcasted are the same in the present embodiment, the display screens may be separately arranged.

### Second Embodiment

A program transmission/reception system according to a second embodiment as an example of the program guide transmission/reception system of the present invention will be described with reference to the drawings. Although the basic configuration of the program transmission/reception system of the present second embodiment is the same as that of the first embodiment, the difference is that the EPG is transmitted through the public line network 3. Therefore, the difference will be mainly described. The same configurations as in the first embodiment are designated with the same reference numerals.

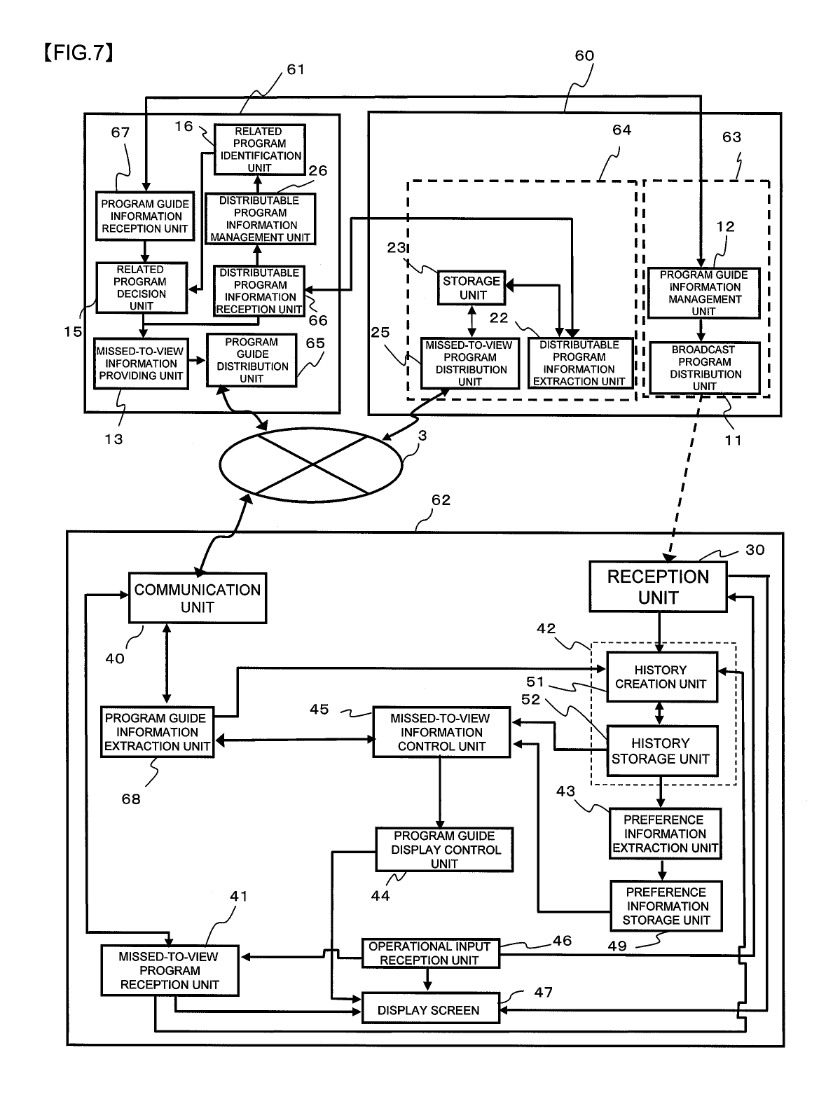

FIG. 7 is a diagram showing the configuration of the program transmission/reception system of the second embodiment according to the present invention. As shown in FIG. 7, the program transmission/reception system according to the present second embodiment comprises a broadcast station 60, a program guide distribution apparatus 61, and a program reception apparatus 62 as an example of the program guide reception terminal of the present invention. The broadcast station 60 and the program guide distribution apparatus 61 correspond to an example of the program distribution apparatus of the present invention.

The broadcast station 60 comprises a normal broadcast program system unit 63 and a missed-to-view program system unit 64. The normal broadcast program system unit 63 comprises the broadcast program distribution unit 11 that broadcasts programs and the program guide information management unit 12 that generates an EPG. The missed-to-view program system unit 64 comprises the storage unit 23, the distributable program information extraction unit 22, and the missed-to-view program distribution unit 25, but does not comprise the distributable program information management unit 26 unlike the missed-to-view program system unit 20 of the first embodiment.

The program guide transmission apparatus 61 according to the present second embodiment comprises a distributable program information reception unit 66 that receives information related to the “Distributable Program” extracted by the distributable program information extraction unit 22, the distributable program information management unit 26 that manages information related to the received “Distributable Program”, the related program identification unit 16 that identifies the “Related Program” based on the information related to the “Distributable Program”, the related program decision unit 15 that decides whether the “Related Program” is in the EPG, a program guide information reception unit 67 that receives information related to the EPG generated by the program guide information management unit 12, the missed-to-view information providing unit 13 that provides the “Missed-to-view” mark to the EPG, and a program guide distribution unit 65 that transmits the EPG to the program reception apparatus 62 through the public line network 3. The EPG may be distributed in response to a request from the program reception apparatus 62, or the EPG may be periodically distributed. The timing of distribution is not particularly limited.

The EPG is transmitted through the public line network 3 in the program reception apparatus 62 according to the present second embodiment. Therefore, compared to the program reception apparatus 4 of the first embodiment, the program reception apparatus 62 does not comprise the program guide information extraction unit 31 that extracts the EPG information from the information received by the reception unit 30, but comprises a program guide information extraction unit 68 that extracts the EPG information from the information received by the communication unit 40.

An example of the program guide information distribution unit of the present invention corresponds to the program guide distribution unit 65 according to the present second embodiment. An example of the program guide information reception unit of the present invention corresponds to the communication unit 40 according to the present second embodiment.

Operations of the program transmission/reception system according to the present second embodiment will be described with reference to the drawings, and examples of the program guide transmission method and the program guide reception method of the present invention will be described at the same time.

First, a process of providing a “Missed-to-view” mark to the EPG will be described.

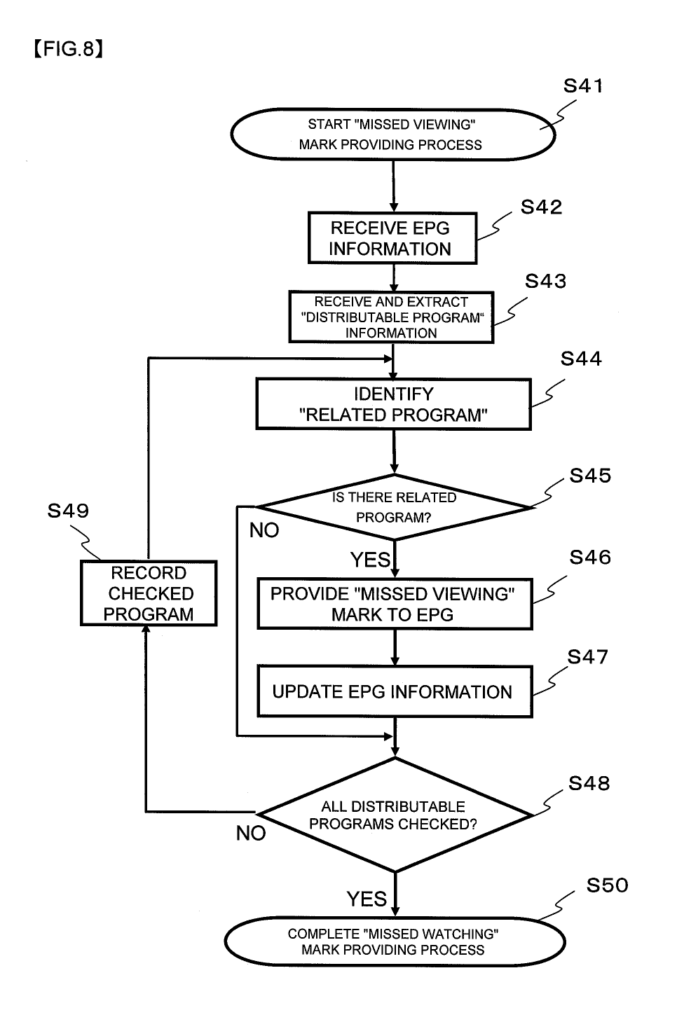

FIG. 8 is a flow chart for explaining a “Missed-to-view” mark providing process until the “Missed-to-view” mark is provided to the EPG in the program guide distribution apparatus 61.

When the providing process of the “Missed-to-view” mark is started in step S41, the program guide information reception unit 67 receives the EPG information from the program guide information management unit 12 in step S42. In step S43, the distributable program information reception unit 66 requests the distributable program information extraction unit 22 for information related to the “Distributable Program” and receives the information. The distributable program information reception unit 66 may execute the following process when the information related to the “Distributable Program” is transmitted, without requesting the information related to the “Distributable Program”. If there are a plurality of “Distributable Programs”, the distributable program information reception unit 66 receives information related to all “Distributable Programs”.

In step S44, the related program identification unit 16 identifies the “Related Program” related to the “Distributable Program” from the extracted information based on a predetermined rule. The details are the same as in the first embodiment, and the description will not be repeated.

When the “Related Program” is identified, the related program decision unit 15 checks in step S45 whether the “Related Program” is in the programs of the EPG of the next two weeks managed by the program guide information management unit 12.

If the “Related Program” is in the EPG in step S45, the existence is transmitted to the missed-to-view information providing unit 13. The missed-to-view information providing unit 13 provides the “Missed-to-view” mark to the frame of the “Related Program” in step S46 and updates the EPG information in step S47. The process proceeds to step S48, and the presence of another “Distributable Program” is checked.

On the other hand, if the “Related Program” is not in the EPG in step S45, the process proceeds to step S48. It is more preferable to periodically check the “Distributable Programs” that are once checked, because the “Distributable Programs” may be in an EPG distributed later.

In step S48, the distributable program information management unit 26 determines whether there is another “Distributable Program”. The process proceeds to step S49 if there is another “Distributable Program”, and the “Distributable Program” for which the distributable program information management unit 26 has checked the presence of the “Related Program” is recorded. The process returns to step S44, and a “Related Program” of another type of “Distributable Program” is identified.

If the process for all “Distributable Programs” is completed, the missed-viewing mark providing process completes in step S50.

The control of the program reception apparatus 62 after the reception of the EPG will be described.

In the program transmission/reception system according to the present second embodiment, when the program reception apparatus 62 receives the EPG from the program guide distribution apparatus 61 through the public line network 3, the program guide information extraction unit 68 extracts the EPG from the communication unit 40. The process after the extraction of the EPG information is the same as in the first embodiment, and the description will not be repeated.

As described, the program that the user likely has actually missed to view (“Missed-to-view Program”) can also be displayed on the EPG in the present second embodiment. In this way, for example, when the user wants to view a missed episode of a drama series before the start of the next episode, the user can well recognize the existence of the “Missed Program” before the start of the next episode triggered by the next episode (related program) just by viewing the EPG frequently used upon viewing TV or upon recording, even if the user forgets the existence of the program missed to view. In this way, missing of continuous programs is also taken into consideration, and the apparatus is significantly user-friendly.

In the first and second embodiments, the EPG displaying the existence of the “Distributable Programs” related to the programs in the EPG (“Missed-to-view” marks) is commonly transmitted to all households in the coverage area, and the program reception apparatus of each user deletes unnecessary “Missed-to-view” marks. In this way, the EPG provided with the “Missed-to-view” marks is created for each program reception apparatus. However, the broadcast station or the program guide distribution apparatus may create the EPG for each household and may distribute the EPG to each household. Specifically, the program reception apparatuses 4 and 62 can transmit the viewing history and the preference information to the broadcast station 1 or the program guide distribution apparatus 61, and excessive “Missed-to-view” marks can be deleted each household. Information related to the “Forgot-to-view Programs” of all users within the range of the radio wave may also be collected, and the same EPG may be distributed to all users.

### Third Embodiment

A program transmission/reception system according to a third embodiment as an example of the program guide transmission/reception system of the present invention will be described with reference to the drawings.

In the first embodiment, the EPG displaying the existence of the “Distributable Programs” related to the programs in the EPG (“Missed-to-view” marks) is commonly transmitted to all households in the coverage area, and the program reception apparatus of each user deletes unnecessary “Missed-to-view” marks. In this way, the EPG provided with the “Missed-to-view” marks is created for each program reception apparatus. In the present third embodiment, the program reception apparatus determines the program that the user forgot to view, and the “Forgot-to-view” mark is provided if the broadcast station can distribute the “Forgot-to-view Program” and if the related “Related Program” is in the EPG. Therefore, the EPG is created for each household and transmitted. In this way, the process of providing the marks to the EPG in the first and second embodiments is different from that in the third embodiment. Therefore, the marks are distinguished by providing “Missed-to-view” marks in the first and second embodiments and “Forgot-to-view” marks in the third embodiment.

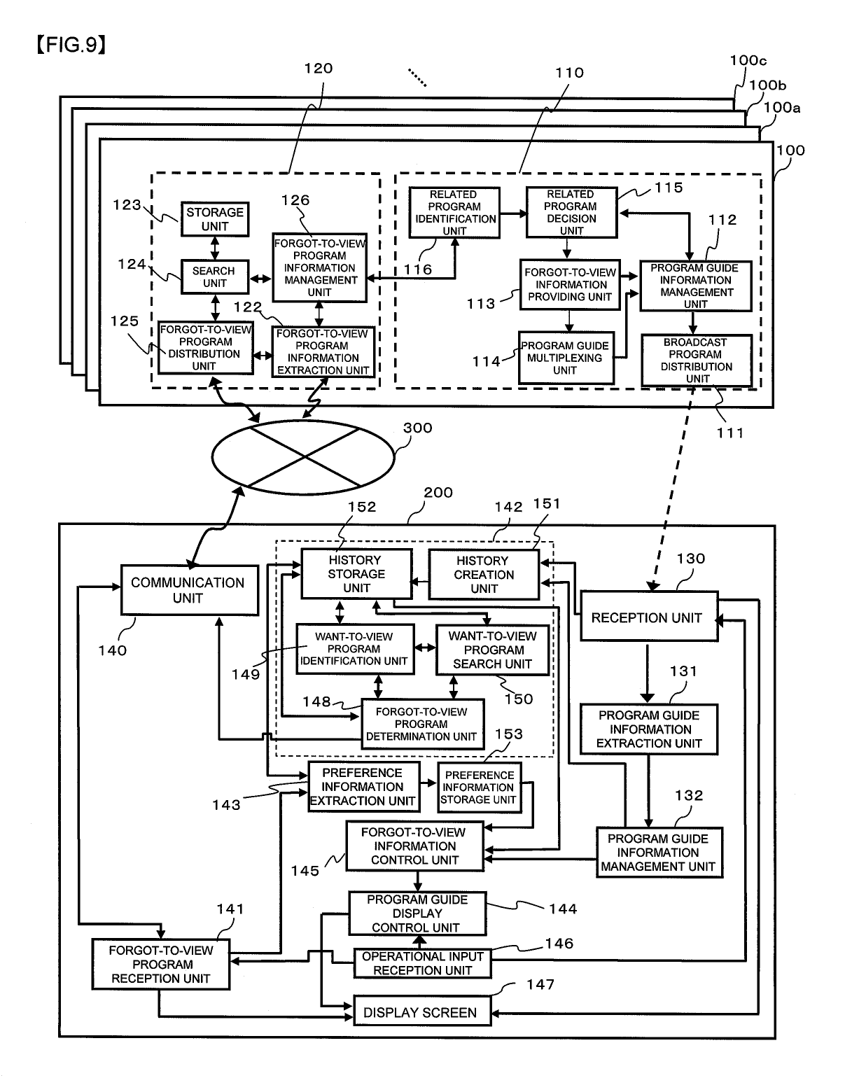

FIG. 9 is a diagram showing a configuration of the program transmission/reception system according to the third embodiment of the present invention.

As shown in FIG. 9, the program transmission/reception system according to the present third embodiment comprises a broadcast station 100 that broadcasts programs and a program reception apparatus 200 possessed by the user to receive broadcasted programs.

The broadcast station 100 according to the present third embodiment comprises a normal broadcast program system unit 110 and a forgot-to-view program system unit 120. Although the normal broadcast denotes digital terrestrial broadcast, BS digital broadcast, etc., the broadcast is not particularly limited as long as the EPG can be generated in the broadcast.

A summary of the program transmission/reception system according to the present third embodiment will be described. The program reception apparatus 200 determines a “Forgot-to-view Program” that the user forgot to view and transmits information related to the “Forgot-to-view Program” to the broadcast station 100 through a public line network 300. If the “Forgot-to-view Program” is in the forgot-to-view program system unit 120 and is distributable, the broadcast station 100 identifies the “Related Program” related to the “Forgot-to-view Program”. If the “Related Program” is in the EPG, the broadcast station 100 provides the “Forgot-to-view” mark to the EPG.

Subsequently, a configuration of the broadcast station 100 corresponding to examples of the program guide distribution apparatus and the program transmission apparatus of the present invention will be described.

The normal broadcast program system unit 110 comprises a broadcast program distribution unit 111 that broadcasts programs, a program guide information management unit 112 that generates an EPG, and a program guide multiplexing unit 114 that multiplexes the EPG with broadcast programs. The normal broadcast program system unit 110 further comprises a related program identification unit 116 that identifies the “Related Program” of the “Forgot-to-view Program”, a related program decision unit 115 that decides whether the identified “Related Program” is in the EPG, and a forgot-to-view information providing unit 113 that provides the forgot-to-view mark to the program field of the “Related Program” if the related program is in the EPG.

The forgot-to-view program system unit 120 comprises a storage unit 123 that stores already broadcasted programs, a search unit 124 that searches programs in the storage unit 123, a forgot-to-view program information management unit 126 that manages information of the searched “Forgot-to-view Programs”, a forgot-to-view program distribution unit 125 that distributes the “Forgot-to-view Programs” to the program reception apparatus 200 in response to a request from the program reception apparatus 200, and a forgot-to-view program information extraction unit 122 that extracts information related to the “Forgot-to-view Programs” received from the program reception apparatus 200. The information related to the “Forgot-to-view Programs” includes program name, broadcast date/time, series program, genre, cast, etc. The information related to the “Forgot-to-view Programs” also includes information indicating whether the “Forgot-to-view Programs” are in the storage unit 123. If the “Forgot-to-view Programs” are in the storage unit 123, information, such as replay time, is also included in the information related to the “Forgot-to-view Programs”.

A configuration of the program reception apparatus 200 corresponding to an example of the program guide reception terminal of the present invention will be described.

The program reception apparatus 200 according to the present third embodiment comprises a reception unit 130 that receives broadcast from the broadcast program distribution unit 111 of the broadcast station 100, a program guide information extraction unit 131 that extracts information related to the EPG from information received by the reception unit 130, and a program guide information management unit 132 that manages the EPG information extracted by the program guide information extraction unit 131.

The program reception apparatus 200 further comprises a history management unit 142 that creates a viewing history based on programs that the user has selected channels to receive and that manages the tendency and history of viewing.

The history management unit 142 comprises a history creation unit 151 that creates a viewing history based on the EPG information in a predetermined past period and based on the received programs, a history storage unit 152 that stores the created viewing history, and a want-to-view program identification unit 149 that identifies the “Want-to-view Programs” of the viewer. The history management unit 142 further comprises a want-to-view program search unit 150 that searches whether the “Want-to-view Programs” identified by the want-to-view program identification unit 149 exist among all programs in a predetermined period (for example, three weeks). The history management unit 142 further comprises a forgot-to-view program determination unit 148 that searches whether there is a not-yet-view program in the “Want-to-view Programs” found by the search if the “Want-to-view Programs” exist and that determines the “Not-yet-view Program” as the “Forgot-to-view Program” if there is an “Not-yet-view Program”.

The “want-to-view program” means such a program that the viewer wants to view. The “not-yet-view program” means such a program that the viewer has not viewed yet.

The program reception apparatus 200 comprises a communication unit 140 connected to the forgot-to-view program system unit 120 of the broadcast station 100 through the public line network 300 such as the Internet.

The program reception apparatus 200 further comprises a reference history extraction unit 143 that extracts a preference history of the user from the viewing history and a preference information storage unit 153 that stores the extracted preference information.

The program reception apparatus 200 comprises a forgot-to-view information control unit 145 that controls the missed-to-view information, such as by changing or deleting a missed viewing mark provided to the extracted EPG, based on the viewing history, the preference information, etc.

The program reception apparatus 200 further comprises an operational input reception unit 146 that receives an operational input from the user and a forgot-to-view program reception unit 141 that receives a “Forgot-to-view Program” from the forgot-to-view program system unit 120 when a “Forgot-to-view” mark is selected by the operational input. Various methods can be used for the user to input the operation, such as by use of a remote control, a touch panel, etc. to directly select a menu from the screen and an operation of a switch, etc. of the TV main body.

A display screen 147 displays the broadcast received by the reception unit 130 or the information related to the broadcast, the “Forgot-to-view Program” received by the forgot-to-view program reception unit 141 or the information related to the “Forgot-to-view Program”, the EPG information, etc. An example of the display screen includes a liquid crystal display. An example of the program reception apparatus 200 includes a TV. The program reception apparatus 200 further comprises a program guide display control unit 144 that controls display of the EPG on the display screen 147.

The forgot-to-view program distribution unit 125 of the broadcast station 100, the forgot-to-view program information extraction unit 122 of the broadcast station 100, and the communication unit 140 of the program reception apparatus 200 are connected through the public line network 300.

An example of the program guide information distribution unit of the present invention corresponds to the broadcast program distribution unit 111 of the present embodiment. An example of the display information providing unit of the present invention corresponds to the forgot-to-view information providing unit 113 of the present embodiment. An example of the program guide information reception unit of the present invention corresponds to the reception unit 130 of the present embodiment. An example of the display information control unit of the present invention corresponds to the forgot-to-view information control unit 145 of the present embodiment.

Operations of the program transmission/reception system according to the present third embodiment will be described with reference to the drawings, and examples of the program guide transmission method and the program guide reception method of the present invention will be described at the same time.

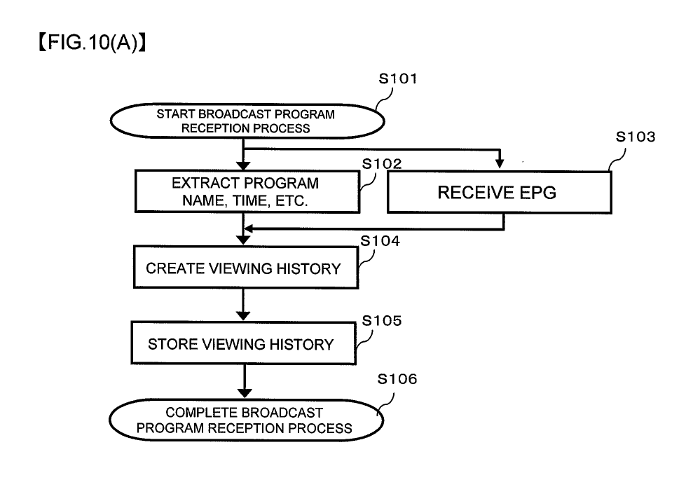

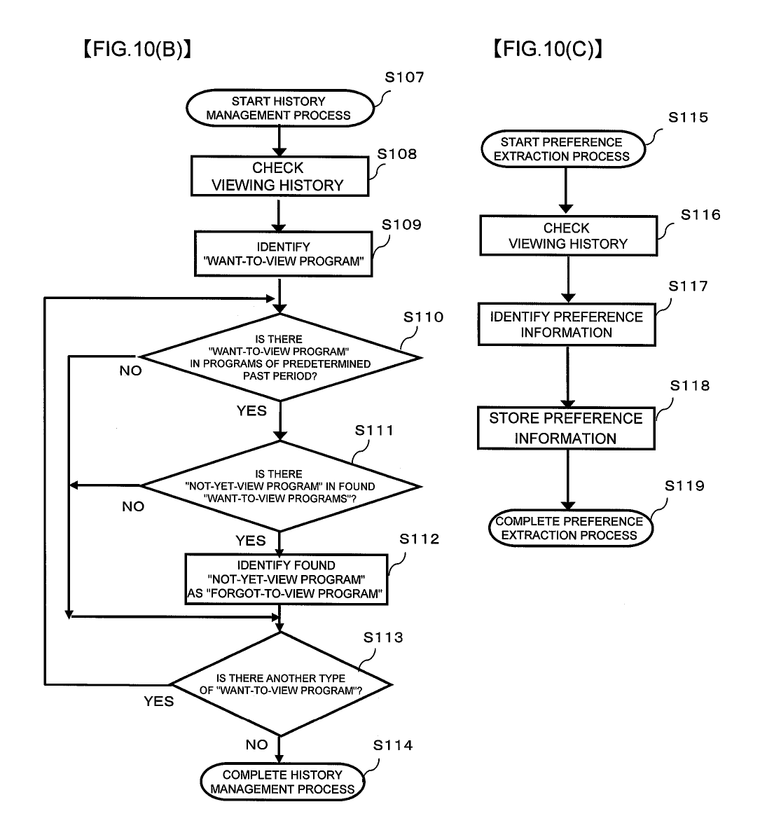

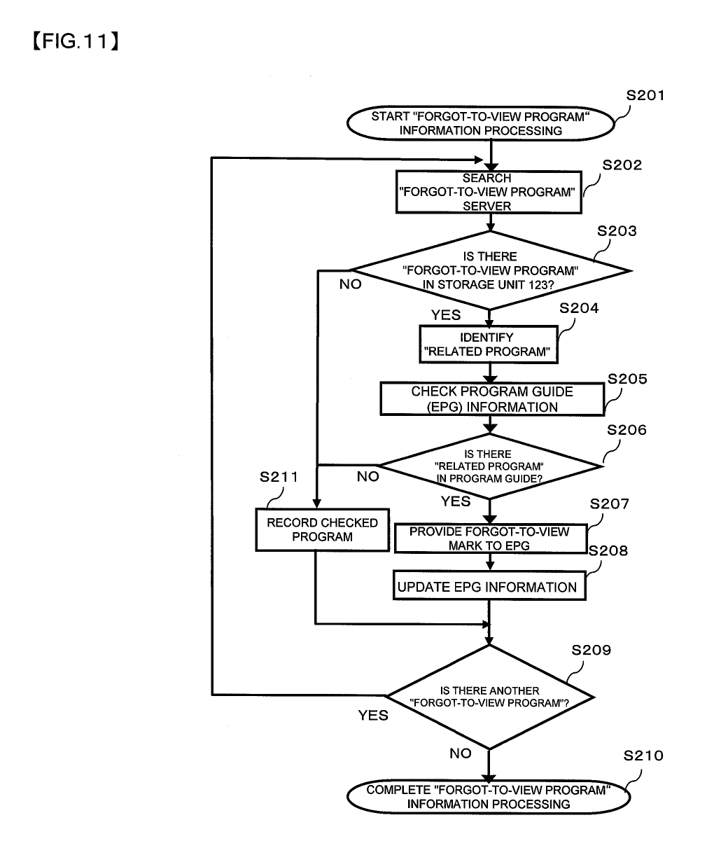

A summary of the operations of the program transmission/reception system of the present embodiment will be described first, and then the operations will be more specifically described using diagrams showing flows of processes as in FIGS. 10(A) to 10(C) and 11.

In FIG. 9, when the user receives broadcast programs by the reception unit 130, the history management unit 142 creates and records a viewing history from the received program names, times, etc. and from past EPG information.

The history management unit 142 identifies a “Forgot-to-view Program” as a program that the user may have forgot to view from the viewing history as described below and transmits information related to the “Forgot-to-view Program” to the broadcast station 100.

The presence of the “Forgot-to-view Program” is searched, and if the “Forgot-to-view Program” is in the forgot-to-view program system unit 120 of the broadcast station 100, the forgot-to-view information providing unit 113 provides the “Forgot-to-view” mark to the “Related Program” as a program related to the “Forgot-to-view Program” in the program guide. The “Related Program” is identified by the related program identification unit 116 and managed by the program guide information management unit 112.

For example, when series programs such as drama are broadcasted, if the user has viewed the first episode but has not viewed the second episode, the second episode is identified as the “Forgot-to-view Program”. The programs following the episode of the drama are identified as the “Related Programs” of the “Forgot-to-view Program (Second Episode)”. More specifically, the second episode is the “Forgot-to-view Program”, and if the second episode is in the forgot-to-view program system unit 120, the “Forgot-to-view” marks are displayed in the frames of the programs of the third and subsequent episodes as the “Related Programs” of the drama in the EPG. Although the “Forgot-to-view” marks may be provided to all program frames following the next episode, the “Forgot-to-view” mark may be provided only to the program of the next episode. The method of providing the marks may be appropriately changed.

When the user selects the “Forgot-to-view” mark displayed on the EPG by an operation of a remote control, etc., the operational input reception unit 146 receives a selection instruction from the remote control and connects communication with the forgot-to-view program system unit 120. The program with the same content as the “Forgot-to-view Program” is transmitted from the forgot-to-view program system unit 120, and the program is received by the forgot-to-view program reception unit 141 and displayed on the display screen 147.

The processes of the program reception apparatus 200 according to the third embodiment of the present invention will be more specifically described with reference to the drawings.

FIGS. 10(A), 10(B), and 10(C) are diagrams showing flows of the processes of the operations executed on a regular basis by the program reception apparatus 200 according to the third embodiment of the present invention. Steps will be abbreviated as “S” in the drawings.

The processes executed by the program reception apparatus 200 on a regular basis (creation of history, identification of “Want-to-view Program”, and identification of “Preference Information”) will be described.

As shown in FIG. 10(A), a broadcast program reception process (step S101) starts when the user receives a broadcast program by the reception unit 130. When the process starts, the history creation unit 151 extracts the received program name, time, etc. (step S102). Meanwhile, EPG information is transmitted to the history creation unit 151 (step S103), and the history creation unit 151 creates a viewing history of the names, times, etc. of the programs viewed in a predetermined past period based on the EPG information, the extracted program names, times, etc. (step S104). The viewing history, the EPG information, etc. are stored in the history storage unit 152 (step S105), and the broadcast program reception process completes (step S106).

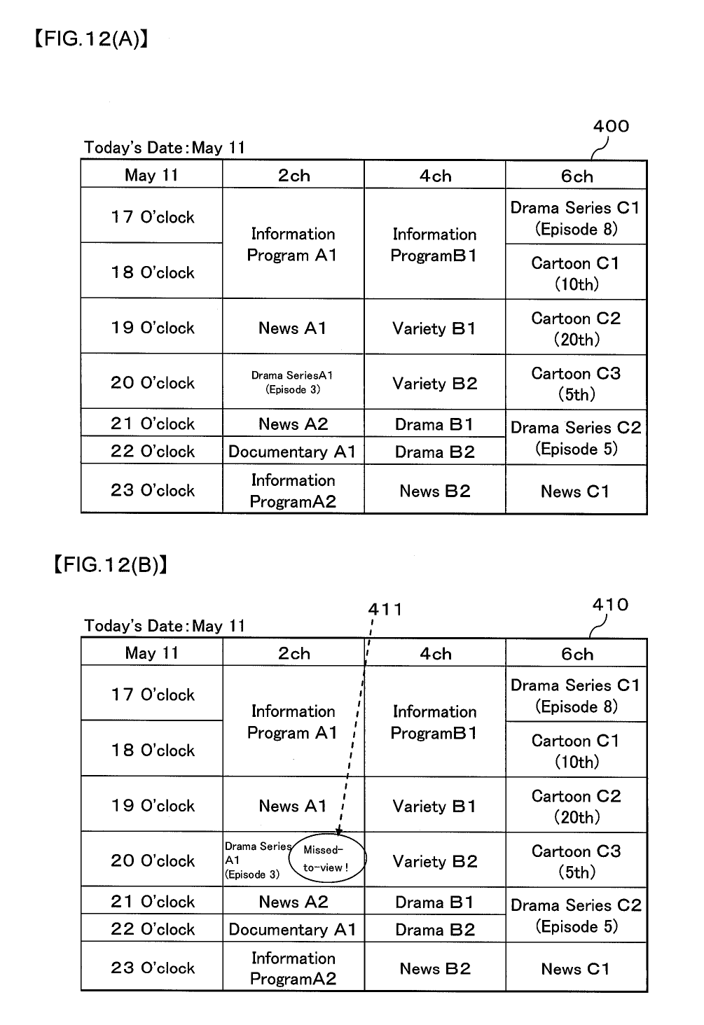

A history management process starts as shown in step S107 of FIG. 10(B), and the history management unit 142 first checks the viewing history based on the viewing history stored in the history storage unit 152 (step S108). The want-to-view program identification unit 149 then identifies the “Want-to-view Programs” of the user based on a predetermined rule (step S109). For example, when the first episode is viewed in series programs such as the drama series A1 broadcasted from 20 o'clock on channel 2 in the EPG shown in FIG. 12(A), the “Want-to-view Programs” are identified as the third episode, the fourth episode, . . . after the second episode of the drama series A1. In this case, the predetermined rule is a rule “if one of the episodes of a drama series is viewed, all programs of the drama series are identified as the “Want-to-view Programs”. A plurality of types of “Want-to-view Programs” may be selected, and for example, Yomiuri Giants vs. Hanshin Tigers of the professional baseball and programs of news A2 of 21 o'clock of channel 2 may be set as the “Want-to-view Programs”. The predetermined rule in this case is a rule “if the number of times of viewing specific programs is significantly greater than the numbers of times of viewing programs of other types (for example, more than three times) statistically in the past viewing history, all the specific programs are identified as the “Want-to-view Programs””.

The history management unit 142 identifies the “Forgot-to-view Program” from the viewing history information managed by the history storage unit 152 (steps S110, S111, and S112).

More specifically, the want-to-view program search unit 150 searches whether the “Want-to-view Programs” identified by the want-to-view program identification unit 149 exist among all programs in a predetermined past period (three weeks) (step S110). If there are a plurality of types of “Want-to-view Programs”, programs of one type are first selected, and whether the selected programs exist among all programs in the predetermined past period is searched. It is assumed here that the drama series A1 is selected.

If there are “Want-to-view Programs”, the forgot-to-view program determination unit 148 searches whether there is a not-yet-view program in the past “Want-to-view Programs” found by the search (step S111). The search of whether there is a “Not-yet-view Program” is performed using the viewing history of the history storage unit 152 and the “Want-to-view Programs” found by the search. If there is a not-yet-view program as a result of the search, the “Not-yet-view Program” is determined as the “Forgot-to-view Program” (step S112). For example, if the second episode of the drama series A1 is not viewed, there is a “Not-yet-view Program” in the “Want-to-view Programs”. Therefore, the second episode of the drama series A1 is determined as the “Forgot-to-view Program”.

On the other hand, if the “Want-to-view Program” is not found among all programs in the predetermined past period (three weeks) in step S109, the control proceeds to step S113, and whether there is another type of “Want-to-view Program” is determined. For example, if there is Yomiuri Giants vs. Hanshin Tigers of the professional baseball as another type of “Want-to-view Program”, the control returns to S110, and whether there are “Want-to-view Programs” of Yomiuri Giants vs. Hanshin Tigers of the professional baseball exist among all programs in the predetermined past period (three weeks) is checked.

The control also proceeds to step S113 if the “Not-yet-view Program” is not found in the “Want-to-view Programs” found by the search in step S111, and whether there is another type of “Want-to-view Program” is determined. After checking all “Want-to-view Programs”, the history management process completes in step S114.

As shown in FIG. 10(C), a preference extraction process of extracting user preference information is also executed. When the preference extraction process starts in step S115, the preference information extraction unit 143 extracts “Preference Information” of the user based on the viewing history stored in the history storage unit 152 and based on a predetermined rule in step S116. For example, if the number of times of viewing the field of the professional baseball is greater than the numbers of times of viewing drama series and news, preference information indicating that the user prefers the professional baseball is extracted. In this case, the predetermined rule is “if the number of times of viewing programs of a specific field is significantly greater than the numbers of times of viewing programs of other fields (for example, more than three times) statistically in the past viewing history, the “Preference Information” is identified by determining that the user prefers the specific field”.

The extracted “Preference Information” is stored in the preference information storage unit 153 in step S118, and the preference information extraction process completes (step S119).

In this way, the broadcast program reception process, the history management process, and the preference extraction process are executed daily.

Operations of the broadcast station 100 to transmit the EPG to the program reception apparatus 200 will be described. Along with the description, an example of a program guide distribution method of the present invention will be described at the same time.

FIG. 11 is a diagram showing a flow of a “Forgot-to-view Program” information process executed by the broadcast station 100 according to the third embodiment of the present invention to transmit the EPG to the user. FIG. 12(A) is a diagram showing an EPG 400 as an example of the EPG. In the EPG, rows or columns will be called fields, and one box will be called a frame.

In the program reception apparatus 200, the forgot-to-view program information extraction unit 122 of the broadcast station 100 receives information related to the identified “Forgot-to-view Program” through the public line network 300 (step S201) to extract the information related to the “Forgot-to-view Program”. In step S202, the search unit 124 searches whether the “Forgot-to-view Program” exists in the storage unit 123.

More specifically, the search unit 124 searches whether the “Forgot-to-view Program” of the second episode of the drama series A1 is stored in the storage unit 123.

If the “Forgot-to-view Program” does not exist in the storage unit 123 as a result of the search in step S202, the process proceeds to NO in step S203. In step S211, the forgot-to-view program information management unit 126 records that the search unit 124 has checked the presence of the “Forgot-to-view Program” of the drama series A1.

The process proceeds to step S209, and the forgot-to-view program information management unit 126 determines whether there is another type of “Want-to-view Program”. The programs, for which the existence in the storage unit 123 has been checked once, may be periodically checked, because the forgot-to-view program may be registered in the storage unit 123 of the forgot-to-view program system unit 120 of the broadcast station 100 later.

On the other hand, if the “Forgot-to-view Program” is in the storage unit 123 in step S203, the related program identification unit 116 identifies the “Related Programs” in accordance with a predetermined rule in step S204. Specifically, the second episode of the drama series A1 of channel 2 is identified as the “Forgot-to-view Program”, and the programs of the episodes following the second episode (or all identified drama series) are identified as the “Related Programs” of the “Forgot-to-view Program”. The predetermined rule this case is a rule “all programs belonging to a “Want-to-view Program” group to which a “Forgot-to-view Program” belongs are identified as “Related Programs” of the “Forgot-to-view Program””. For example, if a predetermined drama series is identified as the “Want-to-view Program” as described, the programs of the episodes after an X-th episode that the user forgot to view (or all predetermined drama series) are identified as the “Related Programs” related to the program of the X-th episode that the user forgot to view. In another case, if Yomiuri Giants vs. Hanshin Tigers is identified as the “Want-to-view Program”, programs of Yomiuri Giants vs. Hanshin Tigers other than the Yomiuri Giants vs. Hanshin Tigers of May 1 that the user forgot to view (which is broadcasted before today) are the “Related Programs”.

When the “Related Programs” are identified in step S204, the related program decision unit 115 checks whether the “Related Programs” of the “Forgot-to-view Program” are in the programs of the EPG of the next two weeks managed by the program guide information management unit 112 (step S205). In step S206, if the “Related Programs” are in the EPG, the existence is transmitted to the forgot-to-view information providing unit 113. Steps S205 and S206 correspond to an example of the related program decision step of the present invention.

On the other hand, if there are no “Related Programs” (the third episode, etc., of the drama series A1 in this case) (step S206), the forgot-to-view program information management unit 126 records the type of the “Forgot-to-view Program” for which the presence of the “Related Programs” is checked (step S211). The control proceeds to step S209, and the forgot-to-view program information management unit 126 determines whether there is another type of “Forgot-to-view Program”. It is more preferable to periodically check the “Related Programs” that are once checked, because the “Related Programs” may be in the EPG distributed later.

If the “Related Program” (the third episode of the drama series in this case) exists in the program guide in step S206, the forgot-to-view information providing unit 113 provides the “Forgot-to-view” mark to the frame of the third episode of the drama series A1 of the EPG (S207) and updates the EPG information (step S208). S207 corresponds to an example of the display information providing step of the present invention.

In step S209, the forgot-to-view program information management unit 126 determines whether there is another type of “Forgot-to-view Program”. If there is another type of “Forgot-to-view Program”, the process returns to step S202, and whether the other type of “Forgot-to-view Program” is in the programs in a predetermined past period is determined. More specifically, after the completion of the process related to the drama series A1, the process of steps S202 to 5208 is executed for Yomiuri Giants vs. Hanshin Tigers of the professional baseball and then for the news A2 that starts from 21 o'clock on channel 2.

If the process related to all types of “Want-to-view Program” is completed, the program guide multiplexing unit 114 multiplexes the EPG provided with the “Forgot-to-view” mark with the broadcast programs. The broadcast program distribution unit 111 transmits the EPG to the program reception apparatus 200, and the “Forgot-to-view Program” information process completes in step S210. The process of transmitting the EPG corresponds to an example of the program guide information distribution step of the present invention.

FIG. 12(B) shows an EPG 410 of an example of the EPG indicated by the “Forgot-to-view” mark. Although FIG. 12(B) shows an example of displaying the “Forgot-to-view” mark 411 only on the third episode of the drama series A1, the “Forgot-to-view” mark is obviously displayed for the news A2 if the news A2 is determined as the “Want-to-view Program” and if there is a “Not-yet-view Program”.

The forgot-to-view information providing unit 113 may request the forgot-to-view program information, or the forgot-to-view program information extraction unit 122 may distribute the forgot-to-view program information. The request timing of the forgot-to-view information providing unit 113 and the distribution timing of the forgot-to-view program information extraction unit 122 are not particularly limited.

If there is no information of the “Forgot-to-view Program” or if there is no program related to the “Forgo-to-view Program” in the transmitted program guide (EPG), the program guide multiplexing unit 114 multiplexes the program guide information generated by the program guide information management unit 112 with the broadcast programs to distribute the EPG from the broadcast program distribution unit 111.

The following example can be considered as a method of transmitting the EPGs created for each household. The EPGs created for each household are encoded by keys that are different household by household, and the EPGs are superimposed on the broadcast and transmitted. The EPGs can be decoded by keys that are different household by household and can be delivered to the households. In an example of IP broadcast using a network, each household can access a server (not shown) that is connected to the broadcast station 100 and that stores the EPG to acquire the EPG through the network. Obviously, even in the case of receiving a broadcast wave, the server storing the EPG can be accessed through the network to acquire the EPG of each household.

The program guide is currently generated and transmitted for each station in the digital terrestrial broadcast. Therefore, if the same process as the process for the broadcast station 100 is executed for other broadcast stations 100a to 100c, the “Forgot-to-view” marks can be provided to the EPGs of all stations.

Although the EPG information provided with the “Forgot-to-view” mark is created for each household and transmitted in the present third embodiment, the EPG information common to all households in the coverage area and the information for providing the “Forgot-to-view” marks of each household may be separately transmitted, and each household may combine the information to display the EPG. Instead of transmitting different EPGs to each household, the information related to the “Forgot-to-view Programs” of all users in the coverage area may be gathered to distribute the same EPG to all users.

A process after the reception of the EPG information by the program reception apparatus 200 according to the third embodiment of the present invention will be more specifically described.

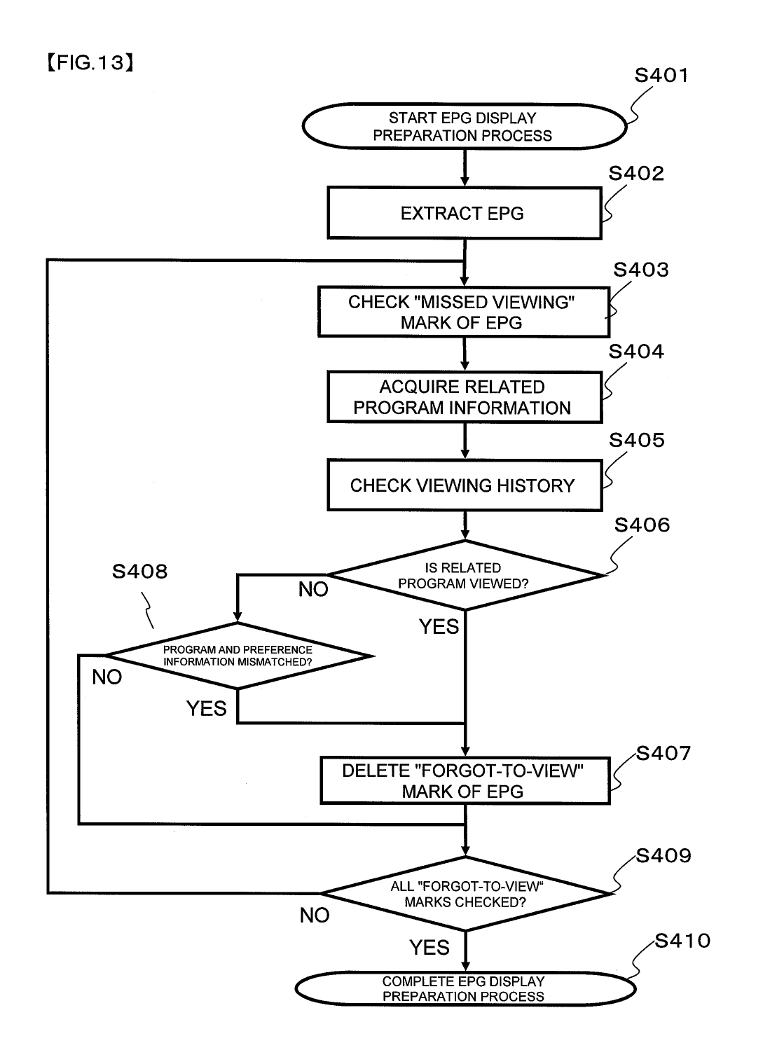

FIG. 13 is a diagram showing a flow of the EPG display preparation process of the program reception apparatus 200 mainly related to forgot-to-view mark display control after the reception of the EPG.

In FIG. 13, when the reception unit 130 of the program reception apparatus 200 receives a broadcast program (step S401), the program guide information extraction unit 131 extracts the EPG from the reception unit 130 (step S402), and the extracted EPG is transmitted to the forgot-to-view information control unit 145 through the program guide information management unit 132. Step S401 corresponds to an example of the program guide information reception step of the present invention.

The forgot-to-view information control unit 145 checks the “Forgot-to-view” marks of the received EPG (step S403) and receives the information of the “Related Programs” provided with the “Forgot-to-view” marks (step S404). The forgot-to-view information control unit 145 may determine the reception of the related program information from the program information of the EPG, or the information may be received from the forgot-to-view program system unit 120 through the communication unit 140. The arrangement is not particularly limited.

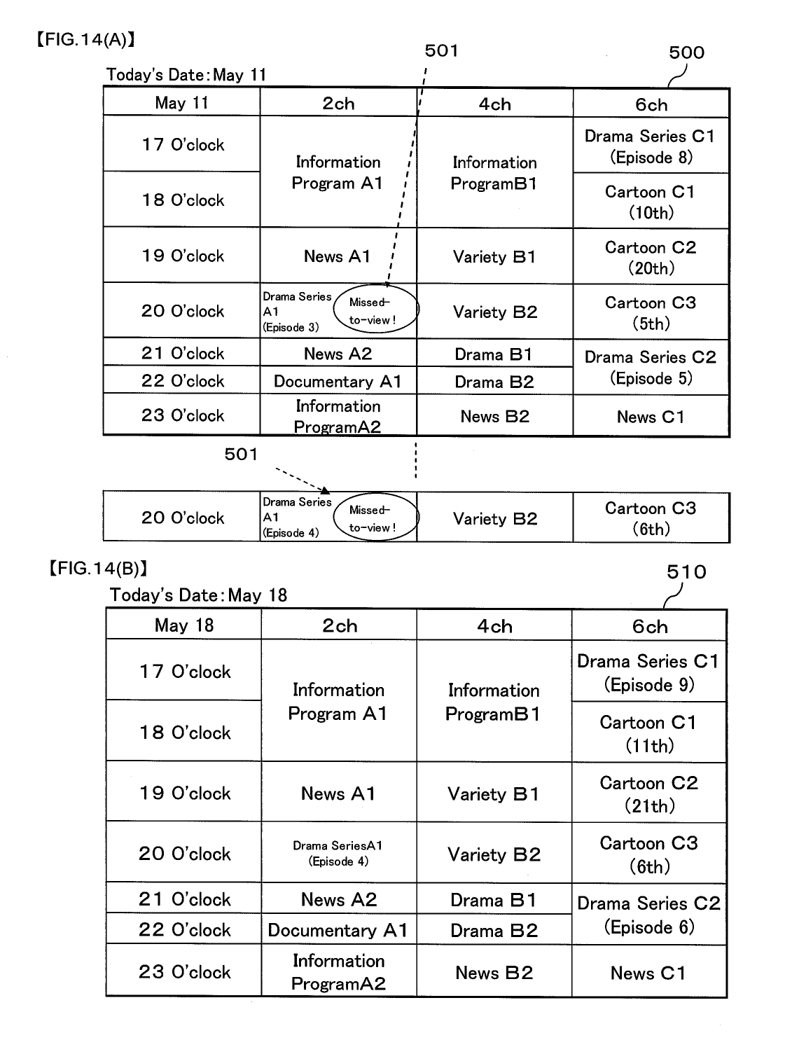

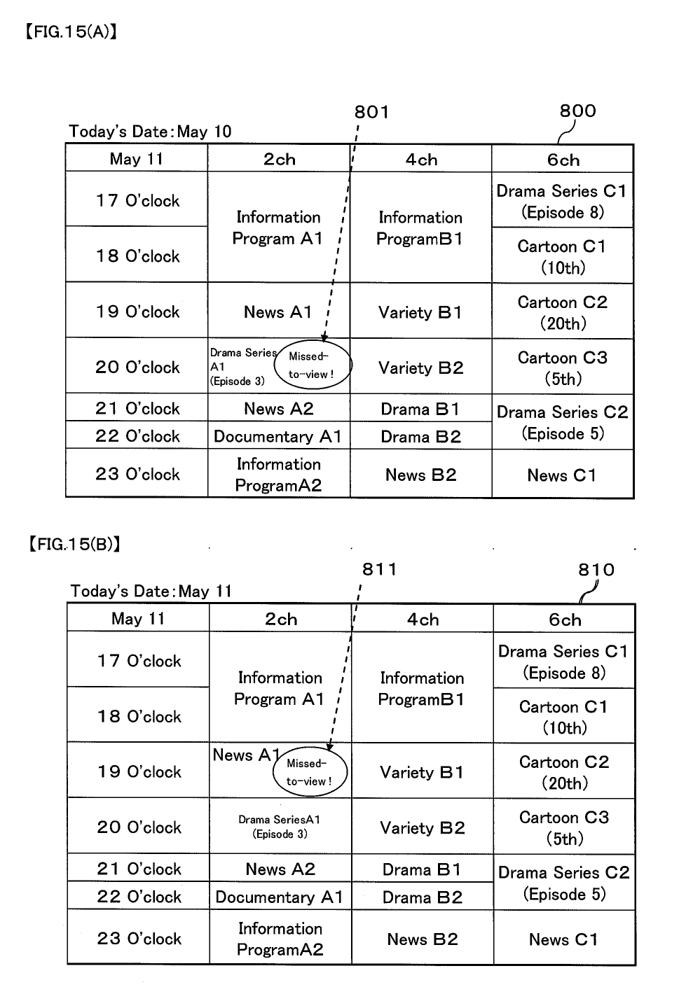

Specifically, as described, the second episode of the drama series A1 is identified as the “Forgot-to-view Program”, and the third and subsequent episodes of the drama series A1 are determined as the “Related Programs”. Therefore, if the drama series A1 is broadcasted every week and information of two weeks is described in the EPG, the third and fourth episodes of the drama series A1 are described in the EPG, and “Forgot-to-view” marks 501 are provided to the third and fourth episodes. FIG. 14(A) illustrates such an EPG 500. Programs from 20 o'clock to 21 o'clock including the drama series A1 (fourth episode) would be checked by scrolling the screen.

After the reception of the related program information, the forgot-to-view information control unit 145 checks the viewing history received from the history management unit 142 (step S405), and if the user has viewed the related program (step S406), the display of the “Forgot-to-view” mark is deleted because the possibility of the user viewing the forgot-to-view program is low (step S407).

More specifically, if the user has viewed the third episode as the “Related Program” without viewing the second episode as the “Forgot-to-view Program”, the possibility of the user viewing the second episode is low, and the “Forgot-to-view” mark provided to the program field of the fourth episode is deleted.

If the user has not viewed the third episode, the forgot-to-view information control unit 145 receives the preference information from the preference information extraction unit 143 and checks whether the “Forgot-to-view Program” and the preference do not match (step S408). If the “Forgot-to-view Program” and the preference do not match, the display of the forgot-to-view mark is deleted because the possibility of the user viewing the forgot-to-view program is low (step S407).

More specifically, if the user has not viewed the second episode as the “Forgot-to-view Program” and has not viewed the third episode as the “Related Program”, the “Forgot-to-view” program and the preference of the user do not match if the preference of the user is “Baseball”. Therefore, the “Forgot-to-view” mark provided to the frame of the fourth episode is deleted because the possibility of the user viewing the drama series A1 in the future is low.

If the “Forgot-to-view Program” and the preference match, the “Forgot-to-view Program” is not viewed when the program is broadcasted in normal broadcast, and the program and the preference match. Therefore, it is determined that the possibility of the user viewing the “Forgot-to-view Program” is high, and the display of the “Forgot-to-view” mark is maintained.

The preference information extraction unit 143 takes the viewing history of the “Forgot-to-view Program” into consideration to extract the preference information. Therefore, if the “Forgot-to-view Programs” are the second and third episodes of the drama series A1, the “Related Program” is the fourth episode, the user has viewed only the second episode, and the preference of the user is changed from “Baseball” to “Drama, Baseball”, the display of the “Forgot-to-view” mark is maintained on the program field of the fourth episode because the “Related Program” and the preference of the user match.

Whether all “Forgot-to-view” marks are similarly checked is determined (step S409), and the preparation of the display of the EPG is completed if all “Forgot-to-view” marks are checked (step S410).

When the user selects to display the EPG through a remote control, etc., the operational input reception unit 146 receives the instruction from the remote control, and the program guide display control unit 144 displays the EPG on the display screen 147.

FIGS. 14(A) and 14(B) are diagrams showing examples of the EPG. The EPG 500 shown in FIG. 14(A) is a state in which an EPG is transmitted from the broadcast station 1. In the state, the “Forgot-to-view” marks 501 are provided. An EPG 510 shown in FIG. 14(B) is a diagram showing a state in which the forgot-to-view information control unit 145 has deleted the “Forgot-to-view” mark from the fourth episode of the drama series A1. Although FIG. 14(A) shows an example of displaying the “Forgot-to-view” marks only on the third and fourth episodes of the drama series A1, the “Forgot-to-view” mark is obviously displayed on the news A2 if the news A2 is determined as the “Want-to-view Program” and there is a “Not-yet-view Program”.

In the display of the EPG shown in FIG. 14(A), if the user presses a determination button of the remote control in the frame of the third episode of the drama series A1, the information of the third episode of the drama series A1 is usually displayed. However, if a specific button, such as a button for data broadcast reception, is pressed, the “Forgot-to-view” mark 501 is selected.

Consequently, the operational input reception unit 146 receives the selection instruction from the remote control, and the program reception apparatus 200 accesses the storage unit 123 of the forgot-to-view program system unit 120 through the communication unit 140. As the forgot-to-view program reception unit 141 receives the “Forgot-to-view Program”, the “Forgot-to-view Program” is displayed on the display screen 147, and the user starts viewing the “Forgot-to-view Program”.

After the reception of the “Forgot-to-view Program”, the forgot-to-view information control unit 145 deletes a “Forgot-to-view” mark 511 from the EPG.

In the present embodiment, if the user forgot to view or record a program, of if there is a “Forgot-to-view Program” that is a program that the user may have forgot to view or record, an icon, etc., indicative of that fact is displayed on the EPG, etc., and the user can recognize the presence of the “Forgot-to-view Program”. As the user selects the icon, the program viewing terminal can replay the “Forgot-to-view Program” that is stored in the broadcast station and that is acquired from the program distribution system.

In this way, in the program transmission/reception system of the present third embodiment, when the user wants to view an episode of a series data, etc., that the user forgot to view before the start of the next episode, the user can well recognize the existence of the “Forgot-to-view Program” before the start of the next episode triggered by the next episode (related program) just by viewing the EPG frequently used upon viewing TV or upon recording, even if the user forgets the existence of the “Forgot-to-view Program”. In this way, missing of continuous programs is also taken into consideration, and the apparatus is significantly user-friendly.

Although the display screen for displaying the EPG and the display screen of the broadcasted programs are the same in the first to third embodiments, the screens may be separately provided.

As described, although the terminal identifies the “Want-to-view Program” on a regular basis, the arrangement is not limited to this. The “Want-to-view Program” may be identified not on a regular basis, but may be identified after the broadcast station 100 transmits a signal for transmitting the EPG to the program reception apparatus 200 and may be transmitted to the broadcast station 100.

Although the present third embodiment illustrates only the display of the “Forgot-to-view” mark in the frame of the “Related Program”, the arrangement is not limited to this. For example, in the EPG, the “Forgot-to-view” mark is displayed in the frame of a program before the “Related Program” on the day of the broadcast of the “Related Program” of the “Forgot-to-view Program”. The “Forgot-to-view” mark is displayed in the frame of the “Related Program” of the “Forgot-to-view Program” before the day of the broadcast of the “Related Program” so that the existence of the “Forgot-to-view Program” can be easily recognized. In this way, the user can appropriately recognize the existence of the “Forgot-to-view Program” in accordance with the date.

Specifically, if the “Related Program” of the “Forgot-to-view Program” is broadcasted on May 11 as shown in FIG. 15(A), the forgot-to-view information providing unit 113 provides a “Forgot-to-view” mark 801 in the frame of the third episode of the drama series A1 as a “Related Program” of the “Forgot-to-view Program” as in an EPG 800 until the day before (May 10 here). As shown in FIG. 15(B), a “Forgot-to-view” mark 811 is provided to a program before the “Related Program”, or in the field of the new A1 here, as in an EPG 810 on May 11 that is the day of the broadcast. Instead of the forgot-to-view information providing unit 113, the forgot-to-view information control unit 145 of the program reception apparatus 200 may move the location of the “Forgot-to-view” mark.

The “Forgot-to-view” mark may be moved on an hourly basis, instead of a daily basis. Specifically, the “Forgot-to-view” mark is displayed in the frame of the “Related Program” until, for example, four hours before the start of the broadcast of the third episode of the drama series A1 as the “Related Program”. The “Forgot-to-view” mark is displayed in the frame of the news A1 that is a program before the “Related Program” if the time until the start of the broadcast of the “Related Program” is less than four hours. In the case of the hourly basis, the “Forgot-to-view” mark cannot be moved four hours before the start of the broadcast of the “Related Program” depending on the timing of the transmission of the EPG. Therefore, it is preferable that the forgot-to-view information control unit 145 of the program reception apparatus 200 moves the “Forgot-to-view” mark.

The modifications of the display position of the “Forgot-to-view” mark can also be applied to the “Missed-to-view” marks described in the first and second embodiments. As described, since the processes of the display on the EPG are different, the “Missed-to-view” marks are provided in the first and second embodiments, and the “Forgot-to-view” marks are provided in the third embodiment to distinguish the “Missed-to-view” marks from the “Forgot-to-view” marks. However, the names are for convenience of the distinction, and it is obvious that the same name can be used.

Although TVs are illustrated as examples of the program reception apparatuses 4, 62, and 200 in the embodiments, the program reception apparatuses 4, 62, and 200 may be recording apparatuses or PCs with broadcast reception functions, instead of the TVs. The apparatuses are not particularly limited as long as the EPG can be received and communication functions are included.

The content of the display of the “Forgot-to-view” mark provided by the forgot-to-view information providing unit 113 is not particularly limited, and for example, the program that the user forgot to view may be specifically described, such as “Forgot-to-view: Drama Series A1, Second Episode”. The same applies to the “Missed-to-view” mark.

Although pressing of the button for data broadcast reception has been described as an example of the method of selecting the “Missed-to-view” mark or the “Forgot-to-view” mark, the method is not particularly limited as long as the selection can be distinguished from normal selection of the program guide.

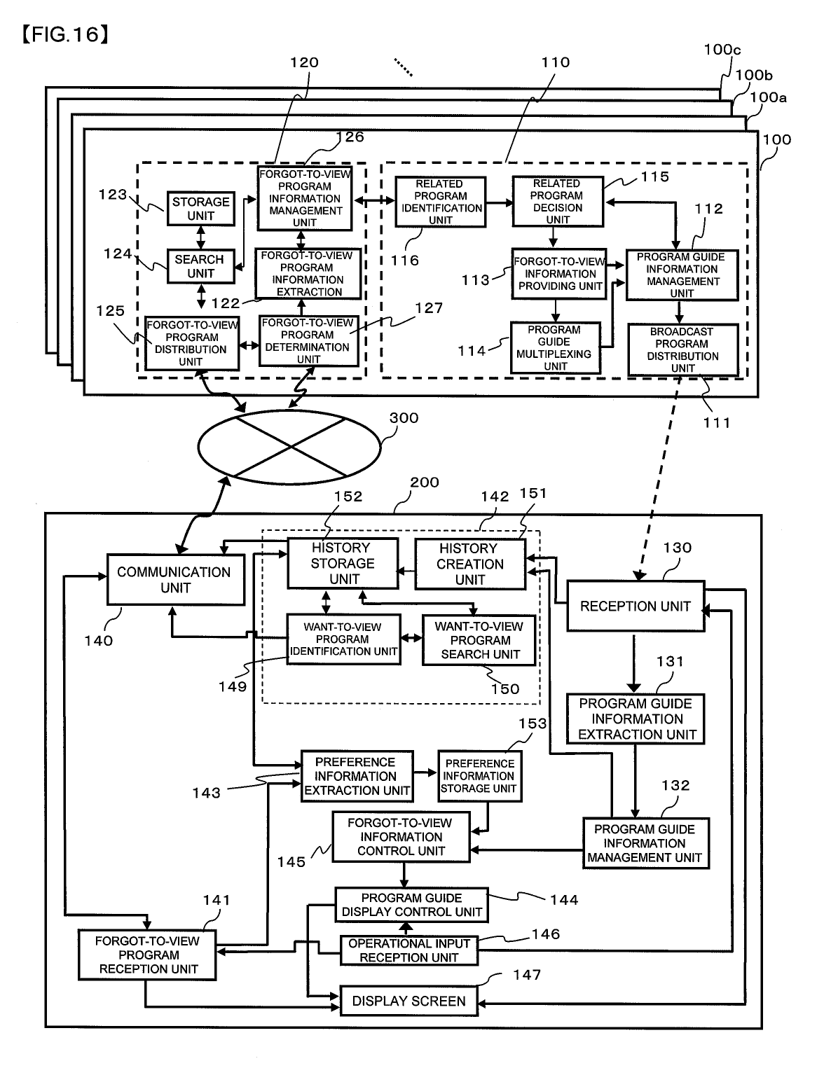

In the present third embodiment, the program reception apparatus 200 determines the “Not-yet-view Program” in the “Want-to-view Programs” as the “Forgot-to-view Program” and transmits the determined “Forgot-to-view Program” to the broadcast station 100. However, the broadcast station 100 may determine the “Forgot-to-view Program”. FIG. 16 shows a configuration of the program transmission/reception system in which the broadcast station determines the “Forgot-to-view Program”. The forgot-to-view program system unit 120 shown in FIG. 16 comprises a forgot-to-view program determination unit 127, and the history management unit 142 of the program reception apparatus 200 does not comprise the forgot-to-view program determination unit 148. According to the configuration, the forgot-to-view program determination unit 127 of the broadcast station 100 determines the “Forgot-to-view Program” based on the “Want-to-view Program” and the “Not-yet-view Program” transmitted from the program reception apparatus 200. The forgot-to-view program information extraction unit 122 extracts the information related to the determined “Forgot-to-view Program”, and the forgot-to-view program information management unit 126 transmits the extracted information related to the “Forgot-to-view Program” to the related program identification unit 116 and instructs the search unit to search the “Forgot-to-view Program”. The related program identification unit 116 identifies the “Related Program” as described above.

In the program transmission/reception system with the configuration of FIG. 16, the program reception apparatus 200 may transmit the information related to the “Want-to-view Program” and the “Not-yet-view Program” when a signal for transmitting the EPG is received from the broadcast station 100 or may periodically transmit the information.

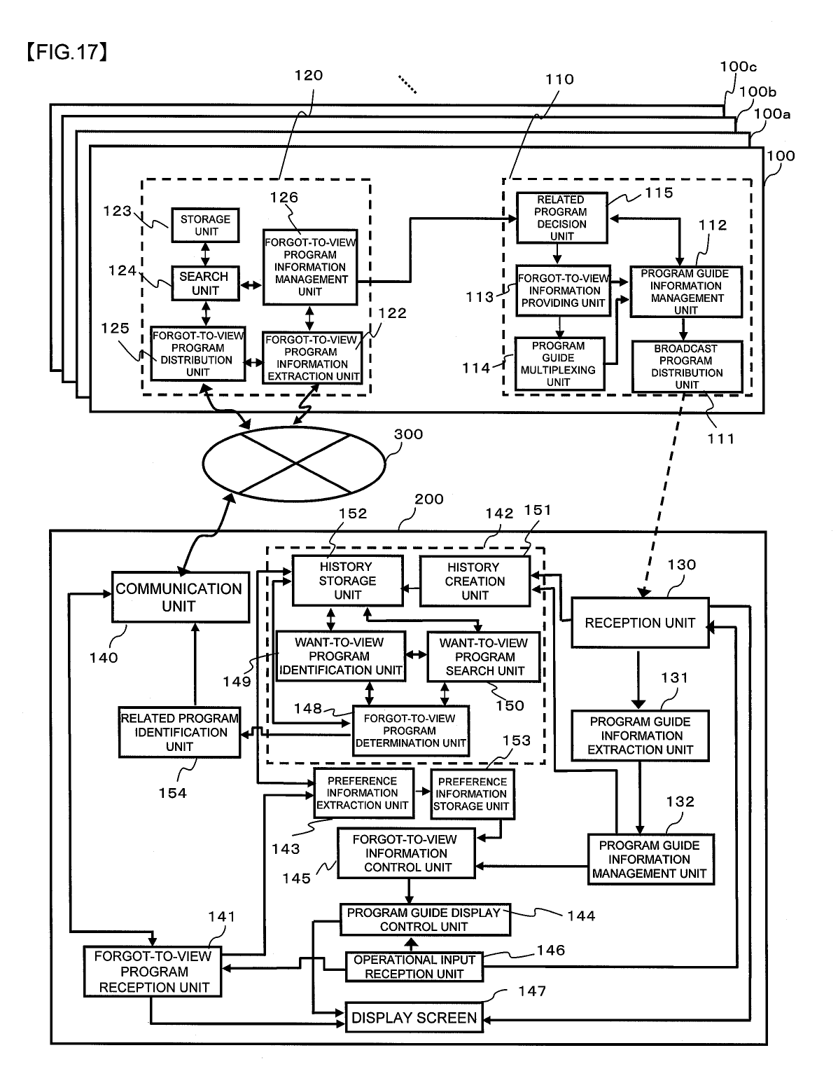

Although the broadcast station 100 identifies the “Related Program” from the “Forgot-to-view Program” transmitted from the program reception apparatus 200 in the present third embodiment, the program reception apparatus 200 may identify the “Related Program”. FIG. 17 shows a configuration of the program transmission/reception system in which the program reception apparatus 200 identifies the “Related Program”. The program reception apparatus 200 shown in FIG. 17 comprises a related program identification unit 154 that identifies the “Related Program” based on the “Forgot-to-view Program” determined by the forgot-to-view program determination unit 148. The normal broadcast program system unit 110 does not comprise the related program identification unit 116. The information related to the “Forgot-to-view Program” and the “Related Program” is transmitted to the broadcast station 100 through the public line network 300, and the forgot-to-view program information extraction unit 122 extracts the information. The extracted information of the “Related Program” is then transmitted to the related program decision unit 115, and as described, whether the “Related Program” exists in the EPG to be transmitted is determined.

In the program transmission/reception system with the configuration of FIG. 17, the program reception apparatus 200 may transmit the information related to the “Forgot-to-view Program” and the “Related Program” when a signal for transmitting the EPG is received from the broadcast station 100 or may periodically transmit the information.

The history management unit 142 may also manage the viewing history of the “Forgot-to-view Program”. Specifically, the information related to the “Forgot-to-view Program” received by the forgot-to-view program reception unit 141 is transmitted to the history creation unit 151. More specifically, if the “Forgot-to-view” mark of the EPG is selected to view the second episode when the second episode of the drama series A1 is the “Forgot-to-view Program” and the third episode is the “Related Program”, the viewing history of viewing the second episode is created by the history creation unit 151 and stored in the history storage unit 152.

Although the preference information extraction units 43 and 143 extract the preference information from the viewing history of the “Missed-to-view Program” and the “Forgot-to-view Program” in the first, second, and third embodiments, the viewing history of the “Missed-to-view Program” and the “Forgot-to-view Program” may not be taken into consideration.

Although the “Forgot-to-view” mark is deleted when the “Forgot-to-view Program” and the preference do not match after the “Related Program” is viewed in the present third embodiment, a process of changing the color of the “Forgot-to-view” mark from red to black may be executed to make the mark inconspicuous, instead of deleting the “Forgot-to-view” mark.

### Fourth Embodiment

A program transmission/reception system according to a fourth embodiment as an example of the program guide transmission/reception system of the present invention will be described with reference to the drawings. Although the basic configuration of the program transmission/reception system according to the present fourth embodiment is the same as that of the third embodiment, the point that the replay time, etc. of the “Forgot-to-view Program” is managed to prompt the user to view the program at more appropriate timing is different from the third embodiment. Therefore, the difference will be mainly described. The configurations that are the same as or corresponding to the configurations of the third embodiment are designated with the same reference numerals.

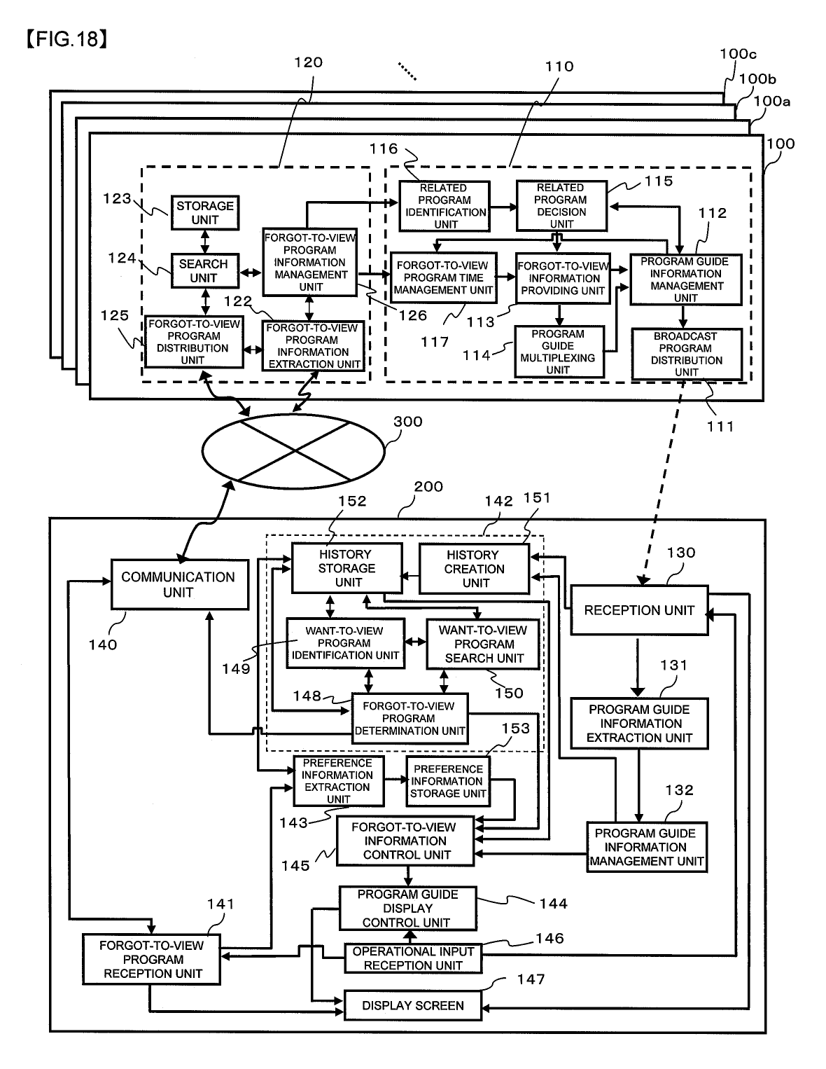

FIG. 18 is a diagram showing a configuration of the program transmission/reception system according to the fourth embodiment of the present invention.

The broadcast station 100 according to the present fourth embodiment shown in FIG. 18 is the same as the broadcast station described in the third embodiment, except that a forgot-to-view program time management unit 117 is installed. Therefore, the description of the other configurations will not be repeated. The forgot-to-view program time management unit 117 manages the start time of the broadcast related to the replay time of the “Forgot-to-view Program”.

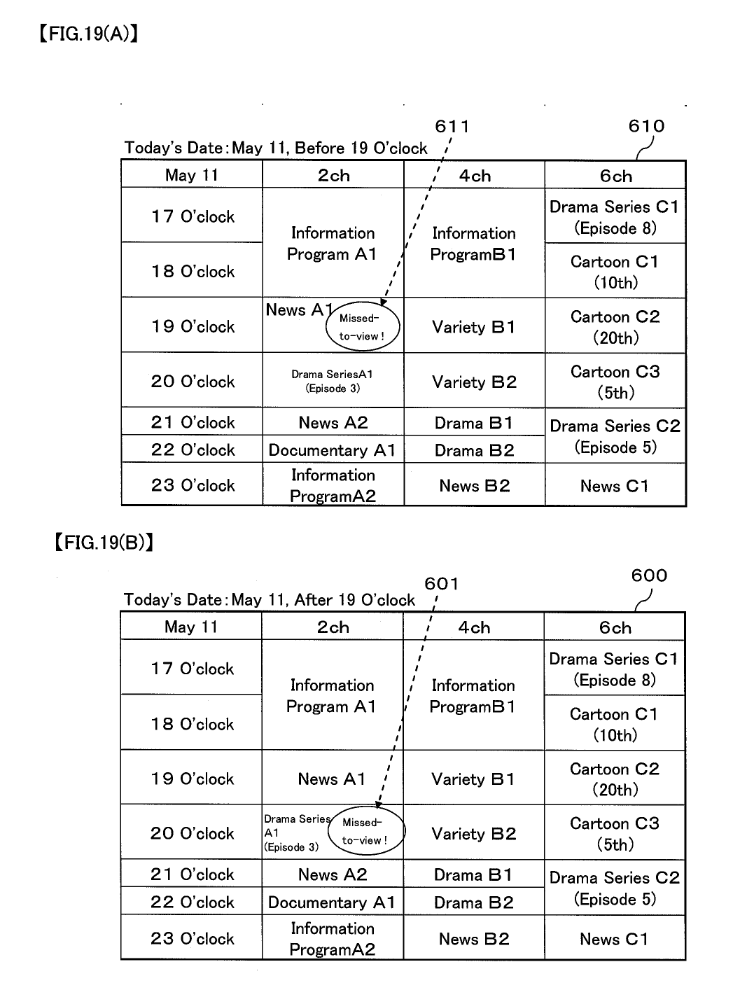

FIGS. 19(A) and 19(B) are diagrams showing examples of the EPG provided with the “Forgot-to-view” mark.

The forgot-to-view program time management unit 117 acquires the replay time of the “Forgot-to-view Program” when the forgot-to-view program information management unit 126 acquires the information of the “Forgot-to-view Program” extracted by the forgot-to-view program information extraction unit 122. The forgot-to-view information providing unit 113 provides the “Forgot-to-view” mark to a program that starts before the start of the “Related Program” and that starts more than the replay time of the “Forgot-to-view Program” earlier than the “Related Program”. Although the forgot-to-view program time management unit 117 acquires the replay time of the “Forgot-to-view Program” through the forgot-to-view program information management unit 126 in FIG. 18, the replay time may be directly acquired from the forgot-to-view program information extraction unit 122.

For example, as shown in FIG. 19(A), if the user has missed to view the second episode that is the episode of the last time of the drama series A1 (third episode) broadcasted from 20 o'clock on channel 2 of an EPG 610, and if the “Forgot-to-view Program” is in the forgot-to-view program system unit 120, the forgot-to-view program time management unit 117 acquires information indicating that the replay time of the drama series A1 (second episode) is one hour. The forgot-to-view program time management unit 117 also acquires information indicating 20 o'clock that is the broadcast start time of the drama series A1 (third episode) as the “Related Program” from the program guide information management unit 112.

As a result, the forgot-to-view program time management unit 117 determines that the user can start viewing the “Forgot-to-view Program” at 19 o'clock that is one hour before the start of the broadcast of the third episode in order to finish viewing the second episode as the “Forgot-to-view Program” before the start of the drama series A1 (third episode) as the “Related Program”. The forgot-to-view program time management unit 117 then transmits information related to the viewing start time to the forgot-to-view information providing unit 113.

Consequently, as shown in the EPG 610 of FIG. 19(A), the forgot-to-view information providing unit 113 provides a “Forgot-to-view” mark 611 to the news A1 as a program that starts from 19 o'clock. As the user selects the “Forgot-to-view Program” at 19 o'clock in the EPG transmitted to the program reception apparatus 200, the user can view the second episode of the drama series A1 as the “Forgot-to-view Program” from 19 o'clock and then continuously view the broadcast of the third episode as the “Related Program” from 20 o'clock.

On the other hand, if the user does not view the “Forgot-to-view Program” after 19 o'clock, the forgot-to-view information control unit 145 displays a “Forgot-to-view” mark 601 in the frame of the drama series A1 (third episode) as shown in an EPG 600 of FIG. 19(B).

In this way, for example, the “Forgot-to-view” mark can be provided to the frame of the EPG broadcasted more than one hour before the next episode in the present fourth embodiment. The fourth embodiment is advantageous that the user can complete viewing the forgot-to-view program before the start of the related next program just by viewing the EPG frequently used upon viewing TV or upon recording if the user has forgot to view a drama series of one hour.

As in the third embodiment, steps S405 to 5410 (see FIG. 13) are also executed in the present fourth embodiment, and the “Forgot-to-view” mark is not displayed in some cases.

Although the forgot-to-view program time management unit 117 is arranged on the broadcast station 100 in the present fourth embodiment, the forgot-to-view program time management unit 117 may be arranged on the program reception apparatus 200. In that case, the information related to the viewing start time is also transmitted when the program reception apparatus 200 transmits the information related to the “Forgot-to-view Program” to the broadcast station 100.

Although the “Forgot-to-view” mark is moved to the frame of the “Related Program” after 19 o'clock in the fourth embodiment, the “Forgot-to-view” mark may not be moved.

The “Forgot-to-view” mark may be provided to a program before the broadcast of the program starting at 19 o'clock which makes the viewing continuous. In this case, the “Forgot-to-view” mark can be provided to a program before 19 o'clock so that the user completes viewing the second episode of the drama series A1 as the “Forgot-to-view Program” before the start of the third episode of the drama series A1.

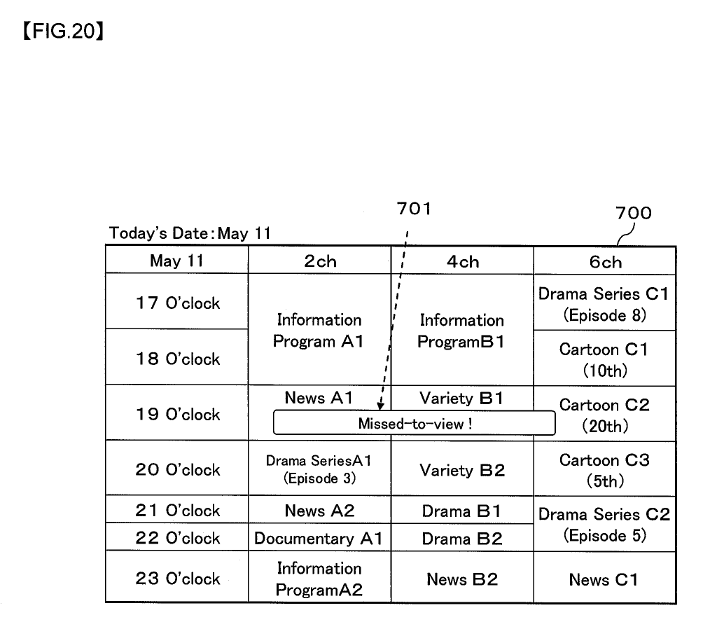

It is more effective if the “Forgot-to-view” mark is provided to EPG frames of a plurality of programs or all programs that allow continuous viewing of the “Forgot-to-view Program” and the “Related Program”. FIG. 20 is a diagram showing an EPG 700 as an example of displaying a “Forgot-to-view” mark 701 to all programs to be broadcasted at 19 o'clock. In the EPG 700 shown in FIG. 20, the “Forgot-to-view” mark 701 is arranged across a plurality of frames of programs to be broadcasted at 19 o'clock that is one hour before the broadcast of the “Related Program”. The “Forgot-to-view” mark arranged across a plurality of frames of programs may be attached to the EPG also in the third embodiment.

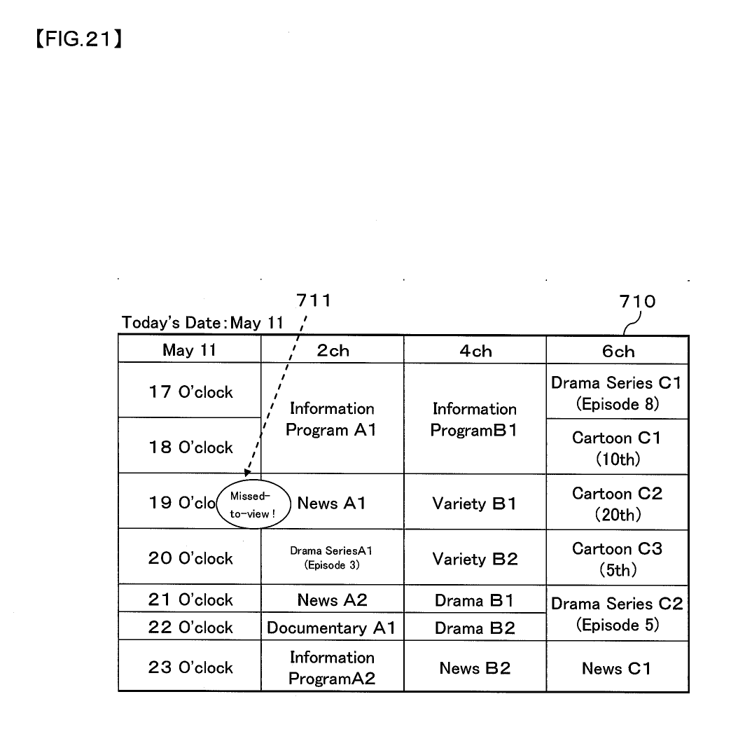

The same advantage can be obtained by providing the “Forgot-to-view” mark to one of the frames of the time display field, not to the program frame of the EPG. FIG. 21 shows an example of such an EPG. In an EPG 710 shown in FIG. 21, a “Forgot-to-view” mark 711 is displayed in the time display frame indicating 19 o'clock. The method of displaying the “Forgot-to-view” mark to one of the frames of the time display field may be applied to the program transmission/reception system of the third embodiment. For example, a “Forgot-to-view” mark 801 shown in FIG. 15(A) may be displayed in the frame of 20 o'clock, and the “Forgot-to-view” mark 811 shown in FIG. 15(B) may be displayed in the frame of 19 o'clock.

The “Forgot-to-view” mark may be provided to the time that allows continuous viewing with the “Related Program”, to the start time of the broadcast of the “Related Program”, to an arbitrary time that viewing is completed before the start of the broadcast, or to the time that the user often views or records programs based on the information of the history management unit 142, in other words, the time or programs that the user likely uses the EPG.

Although an example in which there is one “Forgot-to-view Program” has been described, the present fourth embodiment may also be applied when there are two or more “Forgot-to-view Programs”. Specifically, for example, if the broadcast of the fourth episode starts from 20 o'clock when the user also misses viewing the third episode following the second episode of the drama series A1, the replay time (one hour) of the second episode and the replay time (one hour) of the third episode can be added to set the replay time to a total of two hours, and the “Forgot-to-view” marks can be provided to 18 o'clock that is two hours before the start time of the broadcast. In this way, the same advantage can be obtained even if there are a plurality of forgot-to-view programs.

The advantage of allowing the user to complete viewing the missed-to-view program before the start of the related next program can also be attained in the program transmission/reception systems of the first and second embodiments by providing the forgot-to-view program time management unit 117 as in the present fourth embodiment. The modified examples as in FIGS. 20, 21, etc. can also be applied to the first and second embodiments.

### Fifth Embodiment

A program transmission/reception system according to a fifth embodiment as an example of the program guide transmission/reception system of the present invention will be described with reference to the drawings. Although the basic configuration of the program transmission/reception system according to the present fifth embodiment is the same as that of the third embodiment, the point that the EPG is transmitted through the public line network 300, which is a public line network, is different. Therefore, the difference will be mainly described. The same configurations as in the third embodiment are designated with the same reference numerals.

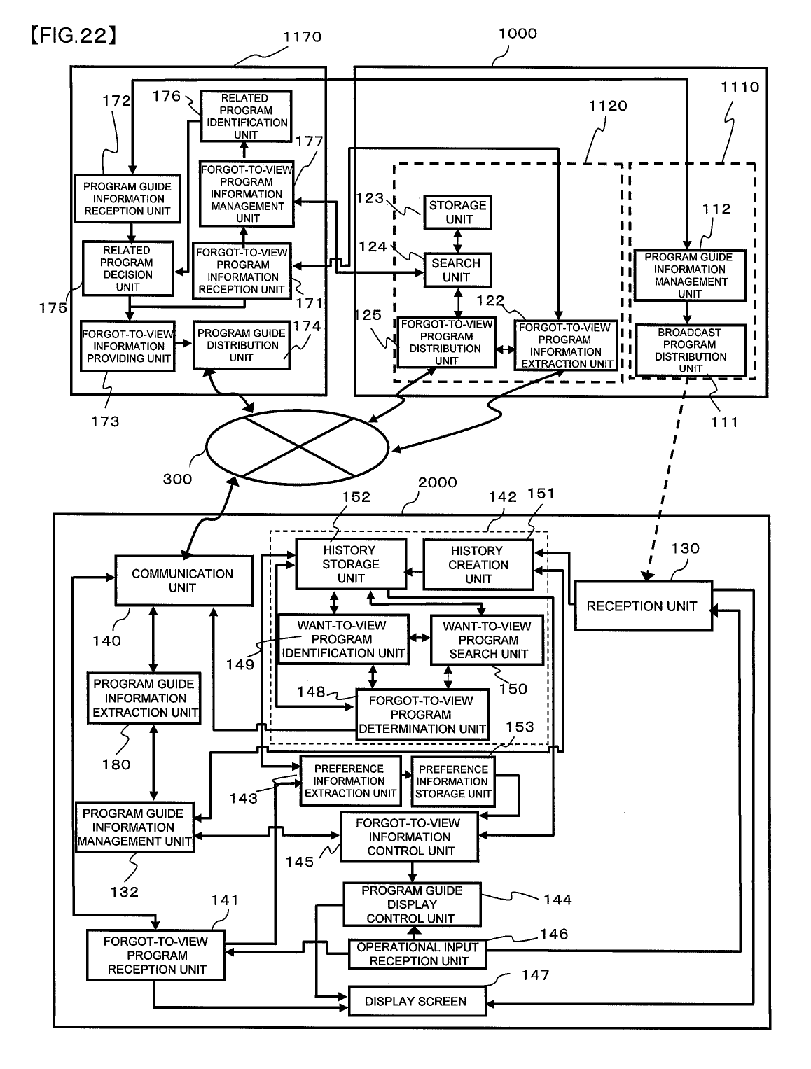

FIG. 22 is a diagram showing the configuration of the program transmission/reception system of the fifth embodiment according to the present invention. As shown in FIG. 22, the program transmission/reception system according to the present fifth embodiment comprises a program reception apparatus 2000 as an example of the program guide reception terminal of the present invention, a broadcast station 1000, and a program guide distribution apparatus 1170.

The broadcast station 1000 comprises a normal broadcast program system unit 1110 and a forgot-to-view program system unit 1120. The normal broadcast program system unit 1110 comprises the broadcast program distribution unit 111 that broadcasts programs and the program guide information management unit 112 that generates an EPG. Unlike the forgot-to-view program system unit 120 of the third embodiment, the forgot-to-view program system unit 1120 does not comprise the forgot-to-view program information management unit 126.

The program guide distribution apparatus 1170 of the present fifth embodiment comprises a program guide distribution unit 174 that transmits the EPG to the program reception apparatus 200 through the public line network 300, a forgot-to-view information providing unit 173 that provides the “Forgot-to-view” mark to the EPG information, a forgot-to-view program information reception unit 171 that receives the information related to the “Forgot-to-view Program” extracted by the forgot-to-view information extraction unit 122, a forgot-to-view program information management unit 177 that manages the information related to the received “Forgot-to-view Program”, a related program identification unit 176 that identifies the related program based on the information related to the “Forgot-to-view Program”, a program guide information reception unit 172 that receives the information related to the EPG from the program guide information management unit 112, and a related program decision unit 175 that decides whether the “Related Program” is in the program guide. The EPG may be distributed in response to a request from the program reception apparatus 2000, and the distribution timing is not particularly limited.

The EPG is transmitted through the public line network 300 in the program reception apparatus 2000 according to the present fifth embodiment. Therefore, compared to the program reception apparatus 200 of the third embodiment, the program guide information extraction unit 131 that extracts the EPG information from the information received by the reception unit 130 is not included, and a program guide information extraction unit 180 that extracts the EPG information from the information received by the communication unit 140 is included.

An example of the program guide information distribution unit of the present invention corresponds to the program guide distribution unit 174 of the present embodiment. An example of the program guide information reception unit of the present invention corresponds to the communication unit 140 of the present embodiment.

Operations of the program guide distribution apparatus 1170 to transmit the EPG will be described.

FIG. 23 is a flow chart of the control of the program guide distribution apparatus 1170 according to the present fifth embodiment.

In FIG. 23, when a “Forgot-to-view Program” information process enters a start state in the program guide distribution apparatus 1170 (step S801), the program guide information reception unit 172 first receives the EPG information from the program guide information management unit 112 (step S802).

The forgot-to-view program information reception unit 171 requests the forgot-to-view program information extraction unit 122 for forgot-to-view information and receives the information (step S803). The following process may be executed when the information related to the “Forgot-to-view Program” is transmitted, without the forgot-to-view program information reception unit 171 requesting for the forgot-to-view program information.

Subsequently, in step S804, the search unit 124 searches whether the “Forgot-to-view Program” is in the storage unit 123.

If there is no “Forgot-to-view Program” in the storage unit 123 in step S805, the forgot-to-view program information management unit 126 records that the search unit 124 has checked the presence of the “Forgot-to-view Program” of the drama series A1 (step S812).

The process proceeds to step S811, and the forgot-to-view program information management unit 177 determines whether there is another type of “Forgot-to-view Program”. Programs, for which the existence in the storage unit 123 is once checked, may also be periodically checked, because the forgot-to-view program may be registered in the storage unit 123 of the forgot-to-view program system unit 1120 of the broadcast station 1000 later.

On the other hand, if the “Forgot-to-view Program” is in the storage unit 123 in step S805, the related program identification unit 116 identifies the “Related Program” in accordance with the predetermined rule in step S806. The identification of the related program is the same as in the third embodiment, and the description will not be repeated.

When the “Related Program” is identified in step S806, the EPG information is checked in step S807, and the related program decision unit 175 checks whether there is a “Related Program” of the “Forgot-to-view Program” in the information related to the EPG (for example, programs of the EPG of the next two weeks) received by the program guide information reception unit 172 (step S808). If the “Related Program” is in the EPG in step S808, the existence is transmitted to the forgot-to-view information providing unit 173.

Consequently, in step S809, the forgot-to-view information providing unit 173 provides a “Forgot-to-view” mark to the frame of the third episode of the drama series A1 of the EPG (step S809) and updates the EPG information (step S810).

In step S811, the forgot-to-view program information management unit 177 determines whether there is another type of “Forgot-to-view Program”. The process returns to step S804 if there is another type of “Forgot-to-view Program”, and whether the other type of “Forgot-to-view Program” is in the programs in a predetermined past period is determined. More specifically, after completion of the process related to the drama series A1, the process of steps S804 to 5810 and 5812 is executed in relation to Yomiuri Giants vs. Hanshin Tigers of the professional baseball and then in relation to the news A2 starting from 21 o'clock of channel 2.

If there is no other type of “Forgot-to-view Program”, whether the same process is necessary for the EPGs and the “Forgot-to-view Programs” of all broadcast stations is checked (step S812). If the same process is necessary for the EPG of another broadcast station, the process returns to step S804, and the process is repeated. If checking of all stations is completed in step S812, the EPG process related to the forgot-to-view program completes (step S813).

The configuration of the program reception apparatus 2000, such as a TV, according to the fifth embodiment of the present invention is the same as that of the third embodiment except that the program guide information extraction unit 180 receives the EPGs of all stations through the communication unit 140. Therefore, the other descriptions will not be repeated.

The control of the program reception apparatus 2000 after the reception of the EPG will be described.

In the program transmission/reception system according to the present fifth embodiment, when the program reception apparatus 2000 receives the EPG from the program guide distribution apparatus 1170 through the public line network 300, the program guide information extraction unit 180 extracts the EPG from the communication unit 140. The process after the extraction of the EPG information is the same as in the third embodiment, and the description will not be repeated.

As in the fourth embodiment, the forgot-to-view program information management unit 126 may also be arranged in the forgot-to-view program system unit 1120 of the broadcast station 1000 or in the program guide distribution apparatus 1170 in the program transmission/reception system according to the present fifth embodiment.

Although arranged in the program guide distribution apparatus 1170 in the present fifth embodiment, the forgot-to-view program information management unit 177 may be arranged in the forgot-to-view program system unit 1120.

The modified examples described in the third and fourth embodiments may also be applied to the present fifth embodiment.

Although the viewing of the present invention denotes, for example, the selection of a channel and the reception of a program in the first to fifth embodiments, whether the program is viewed may be determined based on the display of the program on the display screens 47 and 147 or based on the completion of the display of the program. If the actual display denotes viewing of the program, a program that is received but that is just recorded without being viewed can be handled as the “Forgot-to-view Program”, and this is more user-friendly.

If the “Forgot-to-view Program” is not in the forgot-to-view program system units 120 and 1120 in the third, fourth, and fifth embodiments, the “Forgot-to-view” mark is not displayed even if there is a “Related Program” in the EPG. However, the “Forgot-to-view” mark may be displayed even if the “Forgot-to-view Program” is not in the forgot-to-view program system units 120 and 1120. This is because even if the “Forgot-to-view Program” is not in the forgot-to-view program system units 120 and 1120, the user can acquire a recording medium, etc., before the broadcast of the “Related Program” if the user can recognize that the user is forgetting to view the program.

The control process of the third, fourth, and fifth embodiments is executed in the order of extracting the “Want-to-view Programs” on a regular basis, searching whether there is an “Not-yet-view Program” in the past “Want-to-view Programs”, identifying the “Forgot-to-view Program”, and searching whether the forgot-to-view program system units 120 and 1120 can distribute the “Forgot-to-view Program”. However, the order of the process may be appropriately changed back and forth.

For example, although whether the “Forgot-to-view Program” is in the forgot-to-view program system units 120 and 1120 is searched after the identification of the “Forgot-to-view Program” in the third, fourth, and fifth embodiments, whether the “Want-to-view Program” extracted by the program reception apparatuses 200 and 2000 is in the storage unit 123 may be searched on a regular basis before the identification of the “Forgot-to-view Program”. In that case, the information related to the “Want-to-view Program” is periodically transmitted to the broadcast stations 100 and 1000. The search may be performed when the broadcast station transmits the EPG.

In this way, the control of searching the “Want-to-view Program” in advance has an advantage that less processing is required when the “Want-to-view Program” is not in the storage unit 123, because operations such as the identification of the “Forgot-to-view Program” are not necessary.

Meanwhile, the control of searching whether the “Forgot-to-view Program” is in the storage unit 123 after the identification of the “Forgot-to-view Program” has an advantage that fewer searches are required compared to when the “Want-to-view Program” is searched.

The process of searching whether there are “Want-to-view Programs” among all programs in the EPG of a predetermined past period (three weeks), determining whether there is an “Not-yet-view Program” in the found “Want-to-view Programs”, and determining the program as the “Forgot-to-view Program” if the “Not-yet-view Program” is found is executed in the third, fourth, and fifth embodiments. However, instead of the process in this order, a control process of searching whether there is a “Want-to-view Program” in the “Not-yet-view Programs” after the extraction of the “Not-yet-view Programs” and determining the found program as the “Forgot-to-view Program” may be executed as long as the “Forgot-to-view Program” can be identified.

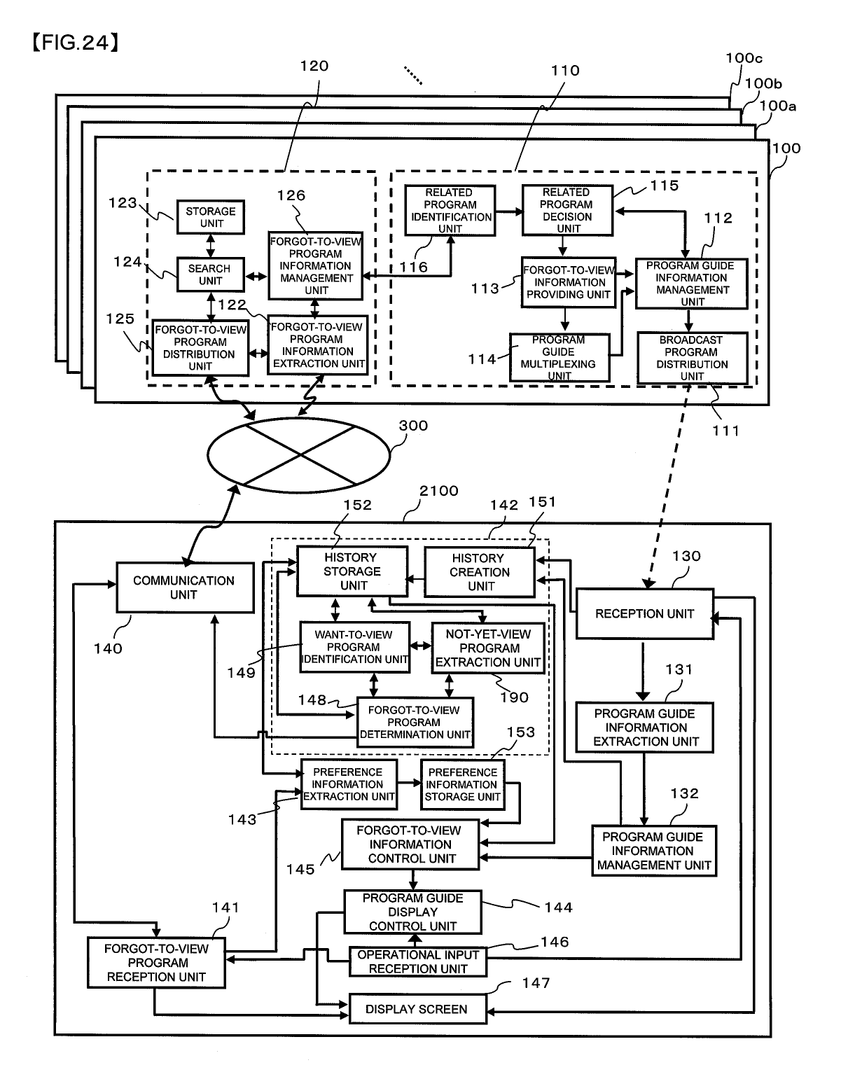

FIG. 24 is a block diagram of the program transmission/reception system that performs control of extracting the “Not-yet-view Programs” first. Compared to FIG. 9, a program reception apparatus 2100 shown in FIG. 24 comprises a not-yet-view program extraction unit 190 in place of the want-to-view program search unit 150. The not-yet-view program extraction unit 190 extracts the “Not-yet-view Programs” in a predetermined past period from the viewing history.

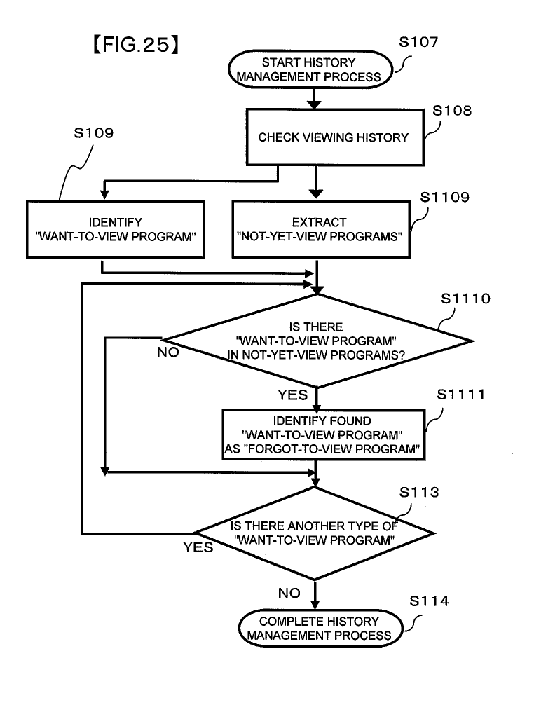

FIG. 25 is a diagram showing a flow of a process executed when the program reception apparatus 2100 shown in FIG. 24 receives a display instruction of the EPG from the user.

As shown in FIG. 25, the program reception apparatus 2100 shown in FIG. 24 determines the “Forgot-to-view Program” as follows on a regular basis.

When a history management process starts in step S107, the not-yet-view program extraction unit 190 checks the viewing history of the user (step S108) and extracts not-yet-view programs (step S1109). The “Want-to-view Program” is identified along with the extraction of the not-yet-view program (step S109).

More specifically, the viewing history stored in the history storage unit 152 includes information of the already viewed programs and the EPG in a predetermined past period. Therefore, the not-yet-view program extraction unit 190 extracts the “Not-yet-view Programs” in the predetermined past period. The predetermined past period can be, for example, three weeks.

The “Want-to-view Program” and the preference information may be identified before or after the extraction step of the “Not-yet-view Programs”.

The history management unit 142 identifies the “Forgot-to-view Program” from the viewing history information managed by the history storage unit 152 (steps S1110 and S1111).

More specifically, the forgot-to-view program determination unit 148 searches whether there is the “Want-to-view Program” identified in step S109 in the “Not-yet-view Programs” extracted in step S1109 (step S1110). If there are a plurality of types of “Want-to-view Program”, one type of program is first selected, and whether the selected program is in the “Not-yet-view Programs” is searched. It is assumed here that the drama series A1 is selected.

If the “Want-to-view Program” is found in the “Not-yet-view Programs” in step S1110, the program is determined as the “Forgot-to-view Program” in step S1111. For example, if the second episode of the drama series A1 is not viewed, the second episode of the drama series A1 is in the “Not-yet-view Programs”. Therefore, the second episode of the drama series A1 is determined as the “Forgot-to-view Program”.

On the other hand, if the “Want-to-view Program” is not found in the “Not-yet-view Programs” in step S1110, the control proceeds to step S113, and whether there is another type of “Want-to-view Program” is determined. For example, if there is Yomiuri Giants vs. Hanshin Tigers of the professional baseball as the other type of “Want-to-view Program” (step S113), the control returns to S1110, and whether the “Want-to-view Program” related to Yomiuri Giants vs. Hanshin Tigers of the professional baseball is in the “Not-yet-view Programs” is checked.

Therefore, in the program reception apparatus with the configuration of FIG. 9, the control is performed to determine the “Not-yet-view Program” in the “Want-to-view Programs” in the predetermined past period as the “Forgot-to-view Program”. In the program reception apparatus with the configuration of FIG. 24, the control is performed to determine the “Want-to-view Program in the “Not-yet-view Programs” in the predetermined past period as the “Forgot-to-view Program”.

In this way, the program reception apparatus with the configuration of FIG. 24 extracts the “Not-yet-view Programs” and searches whether there is a “Want-to-view Program” in the “Not-yet-view Programs”. The program reception apparatus with the configuration of FIG. 9 searches the past “Want-to-view Programs” and searches whether there is an “Not-yet-view Program” in the past “Want-to-view Programs”. However, the “Not-yet-view Program” does not have to be extracted or searched in some cases if the type of the “Want-to-view Program” is a series program, such as a drama series. More specifically, if there is a record of viewing the first and second episodes of the drama series in the viewing history, the third and subsequent episodes are identified as the “Want-to-view Programs”. Assuming that the rest of the drama series is the “Related Program”, if the existence of the fifth episode of the drama series in the EPG is confirmed, the third and fourth episodes can be identified as the “Forgot-to-view Programs”. Therefore, the “Forgot-to-view” mark can be provided to the frame of the fifth episode of the EPG.

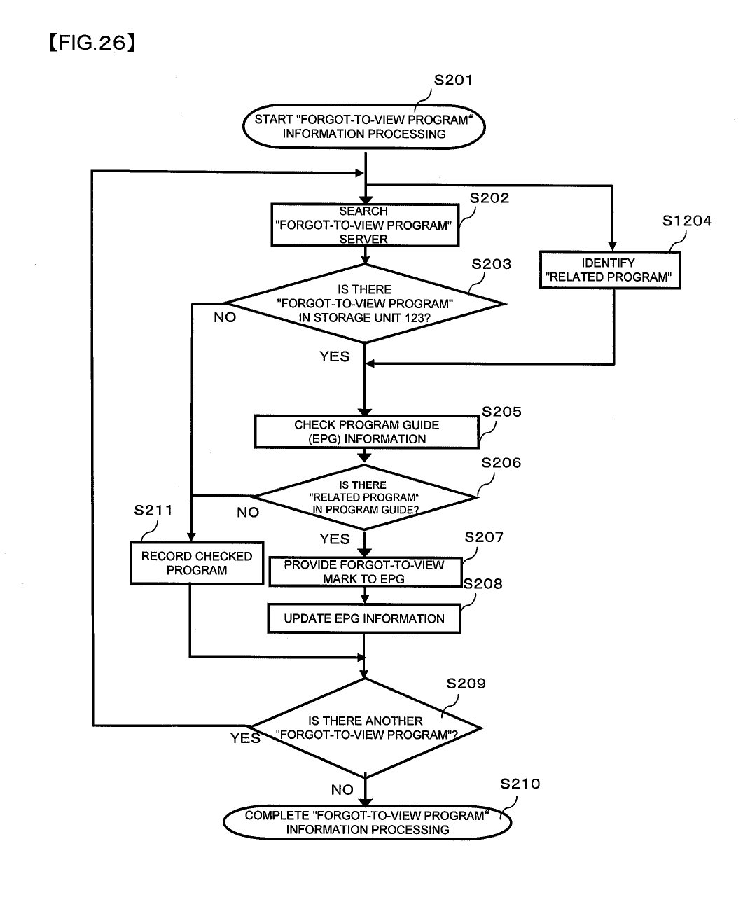

Although the control is performed to identify the “Related Programs” if the “Forgot-to-view Program” is in the storage unit 123 in the third, fourth, and fifth embodiments, the control for identifying the “Related Programs” may be performed in parallel with the search of whether the “Forgot-to-view Program” is in the storage unit (steps S202 and S203). FIG. 26 shows a flow chart of such a control as a modified example of the flow of FIG. 11.

As shown in FIG. 26, the “Related Programs” are identified (step S1204) in parallel with the search of whether there is a “Forgot-to-view Program” in the storage unit 123 (steps S202 and S203). The “Related Programs” may also be identified in parallel with the search of the “Forgot-to-view Program” in the flow of FIG. 23.

Although the broadcast stations 100 and 1100 search the “Forgot-to-view Program” in the third, fourth, and fifth embodiments, the program reception apparatuses 200, 2000, and 2100 may be configured to receive the storage information of the storage unit 123 through the public line network 300 to search the storage information. In that case, the search unit is arranged on the program reception apparatus.

In the first and second embodiments, the case in which the “Missed-to-view” mark is simply provided to the “Related Program” (see FIGS. 3(B) and 6(B)) has been described. In the third embodiment, the case in which the “Forgot-to-view” mark is simply provided to the “Related Program” (see FIG. 12(B)), the case in which the “Forgot-to-view” mark is provided to the frame of the “Related Program” until one day before the broadcast of the “Related Program” and providing the “Forgot-to-view” mark to the frame of a program earlier than the start time of the broadcast of the “Related Program” on the day of the broadcast (see FIGS. 15(A) and 15(B)), and the case of providing the “Forgot-to-view” mark to the frame of the “Related Program” until a predetermined time before the start time of the broadcast of the “Related Program” and providing the “Forgot-to-view” mark to the frame of a program earlier than the start time of the broadcast of the “Related Program” after the predetermined time before the start time of the broadcast have been described.

In the fourth embodiment, the case in which the time that is by the replay time of the “Forgot-to-view Program” earlier than the start of the broadcast of the “Related Program” is set as a reference, the “Forgot-to-view” mark is provided to the frame of a program aired earlier than the “Related Program” before the time, and the “Forgot-to-view” mark is provided to the frame of the “Related Program” after the time (see FIGS. 19(A) and 19(B)), the case in which the “Forgot-to-view” mark is provided across a plurality of other channels (see FIG. 20), and the case in which the “Forgot-to-view” mark is displayed on the frame of the time display field (see FIG. 21) have been described.

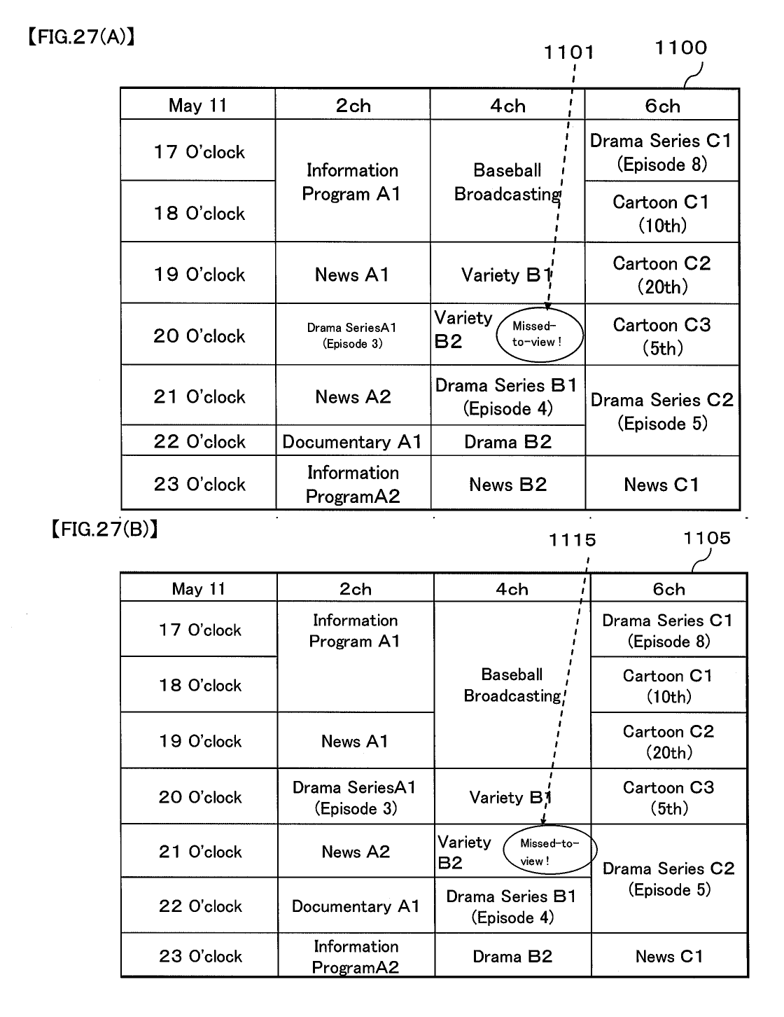

Although a plurality of examples of providing the “Missed-to-view” mark and the “Forgot-to-view” mark have been described in the embodiments, the missed-to-view information providing unit 13 or the forgot-to-view information providing unit 113 may change the location of the “Missed-to-view” mark or the “Forgot-to-view” mark if the start time of the “Related Program” is changed. An EPG 1100 as shown in FIG. 27(A) will be specifically described as an example. If a third episode of a drama series B1 starting from 21 o'clock on channel 4 is the “Forgot-to-view Program”, a fourth episode of the drama series B1 is the “Related Program”. If baseball broadcasting B3 that is broadcasted before a variety B2 is extended by one hour when a “Forgot-to-view” mark 1101 is provided to the frame of the variety B2 that is a program before the start time of the broadcast time of the fourth episode of the drama series B1, other programs are also postponed by one hour. Therefore, as shown in an EPG 1105 of FIG. 27(B), a “Forgot-to-view” mark 1115 is provided one hour later than in FIG. 27(A). If the “Forgot-to-view” mark is shown in the frame of the “Related Program” as shown in FIG. 11(B), the “Forgot-to-view” mark can be moved in accordance with the movement of the “Related Program”.

When the “Forgot-to-view” mark is provided to a program that is in the same channel field as the “Related Program” and that is aired earlier than the “Related Program”, the forgot-to-view information control unit 145 may perform the control to sequentially move down the “Forgot-to-view” mark if the “Forgot-to-view” program is not viewed before the start time of the broadcast of the program provided with the “Forgot-to-view” mark.

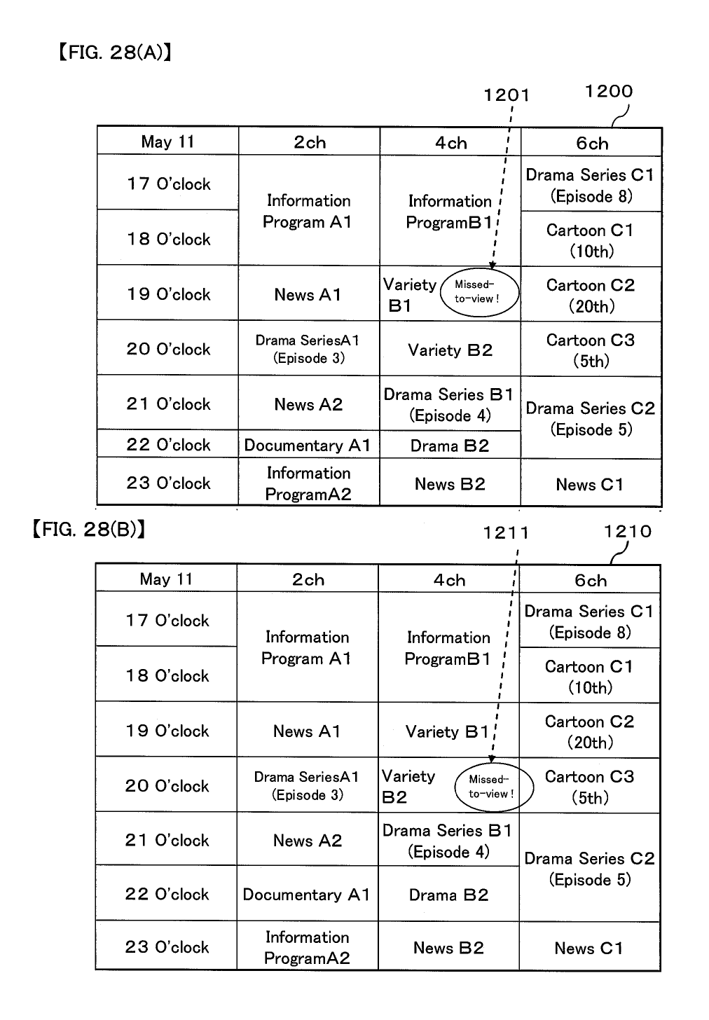

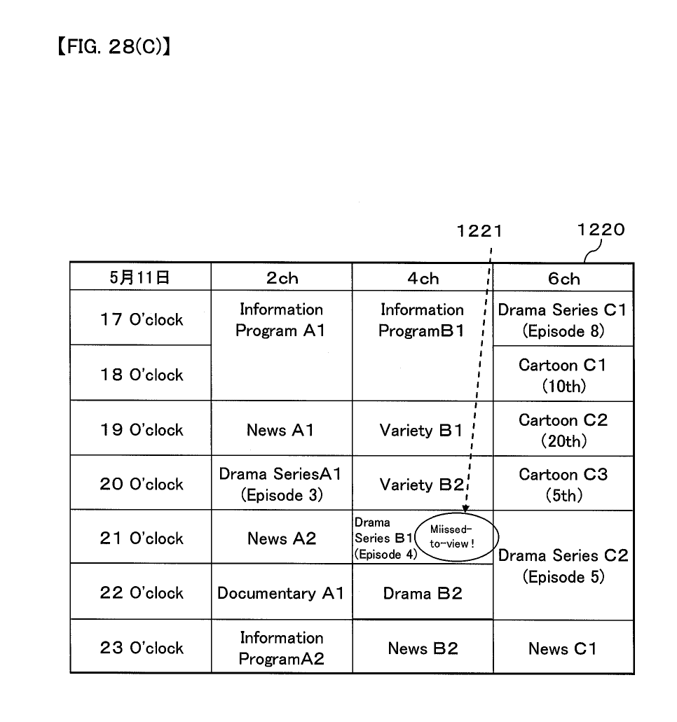

More specifically, if the third episode of the drama series B1 starting from 21 o'clock on channel 4 is the “Forgot-to-view Program”, the fourth episode of the drama series B1 is the “Related Program” as shown in an EPG 1200 of FIG. 28(A). A “Forgot-to-view” mark 1201 is provided to the frame of the variety B1 aired from 19 o'clock in the EPG 1200. If the “Forgot-to-view Program” is not viewed until 19 o'clock, a “Forgot-to-view Program” mark 1211 is provided to the frame of the variety B2 that is the program following the variety B1 as in an EPG 1210 shown in FIG. 28(B). Subsequently, if the “Forgot-to-view Program” is not viewed until 20 o'clock which is the start time of the variety B2, a “Forgot-to-view” mark 1221 is provided to the frame of the fourth episode of the drama series B1 as the “Related Program” as in an EPG 1220 shown in FIG. 28(C).

In FIGS. 28(A) to (C), the “Forgot-to-view” mark 1201 is moved to the following program frames if the “Forgot-to-view Program” is not viewed at the start of the program provided with the “Forgot-to-view” mark 1201. However, the forgot-to-view information control unit 145 may perform control to move the “Forgot-to-view” mark 1201 to the following program frames after a predetermined time from the start of the program. The predetermined time may be set to an arbitrary time, and the predetermined time can be set at the end time of the program.

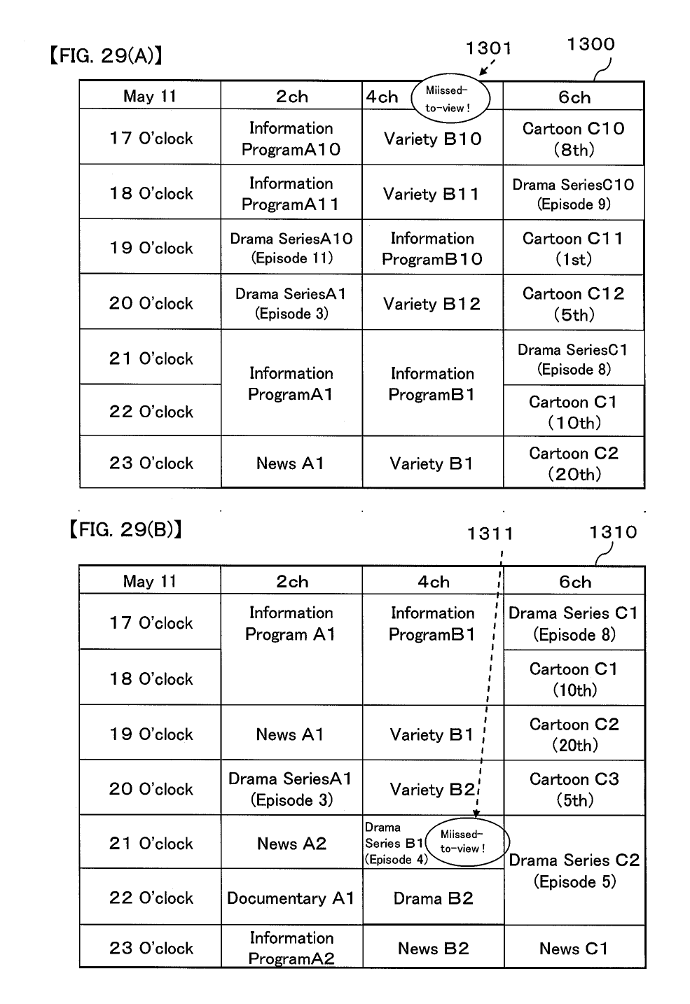

If a program for displaying the “Forgot-to-view” mark does not appear on the EPG (not scrolled) currently displayed on the display screen 147, control may be performed to provide the mark in a channel frame of the channel display field. A specific example will be described. If the third episode of the drama series B1 aired from 21 o'clock on channel 4 is the “Forgot-to-view Program”, the fourth episode of the drama series B1 is identified as the “Related Program”. If the “Forgot-to-view” mark is provided to the “Related Program”, the program guide of 20 o'clock is not displayed as shown in FIG. 29(A) even if an EPG 1300 is displayed on the display screen 147. Therefore, the user cannot visually check the “Forgot-to-view” mark unless the screen is scrolled. Thus, a “Forgot-to-view” mark 1301 is provided to the channel display frame in which the “Related Program” is aired (see FIG. 29(A)).

When the program guide from 20 o'clock to 21 o'clock is displayed as shown in FIG. 29(B), such as by scrolling the screen, the forgot-to-view information control unit 145 performs control to display a “Forgot-to-view” mark 1311 in the frame of the “Related Program”.

As a result of the control, the “Forgot-to-view” mark is provided to the channel program field when the program, for which the “Forgot-to-view” mark is planned to be displayed, is not currently displayed on the display screen. Therefore, the user can better recognize the existence of the “Forgot-to-view Program”.

If the remote control is used to instruct the display of the EPG, the currently broadcasted program frames are displayed. Therefore, the control may be performed to display the “Forgot-to-view” mark in the program frames. If the channel is changed, or if the broadcast is shifted to the program of the next time zone, the control is performed to move the “Forgot-to-view” mark to the program of the next time zone in association with the movement of the program.

The modified examples of FIGS. 27 to 29 can also be applied to the first and second embodiments.

In the embodiments, the reception of the “Missed-to-view Program” or the “Forgot-to-view Program” serves as an example of viewing in the present invention, and after the reception, the missed-to-view information providing unit 13 or the forgot-to-view information providing unit 113 deletes the “Missed-to-view” mark or the “Forgot-to-view” mark from the EPG. However, the arrangement is not limited to this. The display of the “Missed-to-view Program” or the “Forgot-to-view Program” on the display screen 147 or the completion of the display of the “Missed-to-view Program” or the “Forgot-to-view Program” on the display screen may serve as an example of viewing in the present invention, and after the display or after the completion of the display, the “Forgot-to-view” mark may be deleted from the EPG.

If the user does not view the “Missed-to-view Program” or the “Forgot-to-view Program”, control may be performed to delete the “Missed-to-view” mark or the “Forgot-to-view” mark from the EPG at the start of the broadcast of the program, for which the existence of the “Missed-to-view Program” or the “Forgot-to-view Program” is displayed, or after a certain time from the start of the broadcast. For example, the “Forgot-to-view” mark may be deleted from the EPG at the start of the broadcast of the news A1 broadcasted before the third episode of the drama series A1 as the “Related Program” or after 30 minutes from the start of the broadcast as shown in FIG. 12(B).

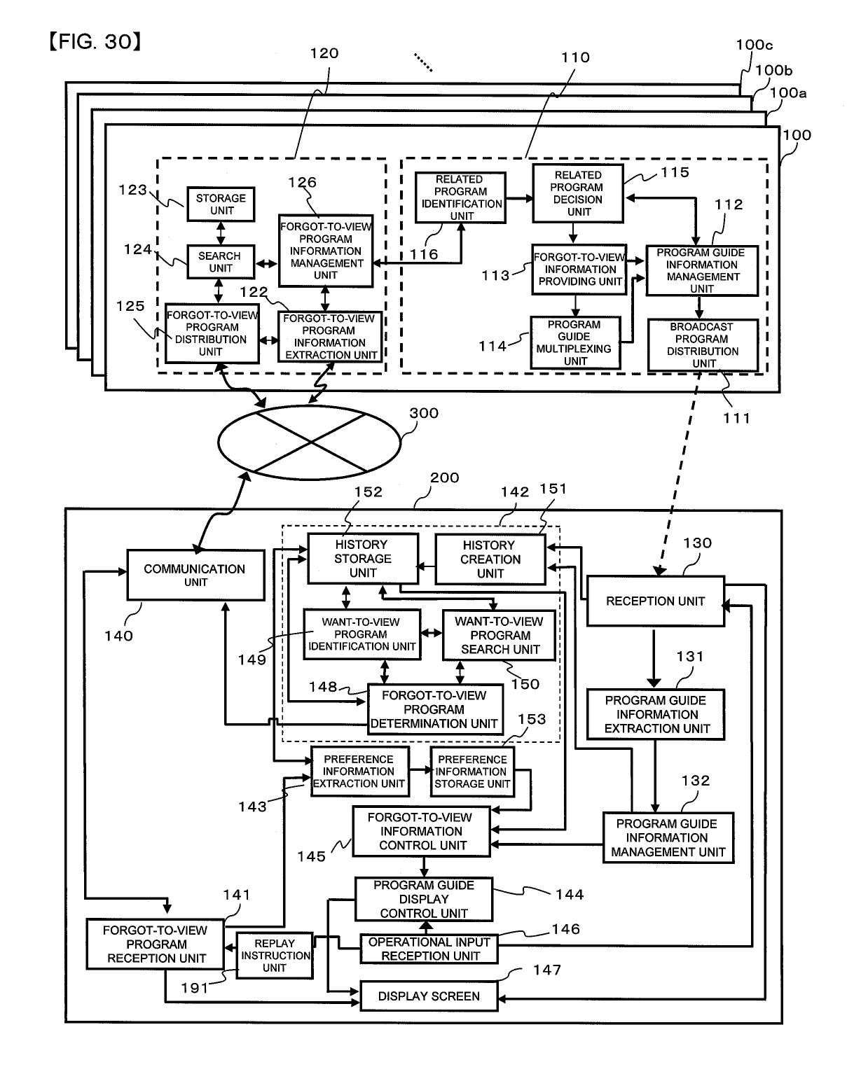

Although the “Forgot-to-view Program” is distributed and the display is started when the “Forgot-to-view” mark of the EPG is selected in the embodiments, and displaying “Forgot-to-view Program” is started, the timing of the start may be a predetermined timing. Displaying “Forgot-to-view Program” may be not started continuously after selecting the “Forgot-to-view” mark and receiving the “Forgot-to-view program”. FIG. 30 shows a configuration of the program transmission/reception system that performs such a control. The program transmission/reception system shown in FIG. 30 comprises a replay instruction unit 191 that issues a reception instruction of the “Forgot-to-view Program” to the forgot-to-view program reception unit 141 at a predetermined timing in response to a signal received by the operational input reception unit 146.

More specifically, for example, even if the user selects the “Forgot-to-view” mark at 18 o'clock in the EPG 610 of FIG. 19(A) of the fourth embodiment, the replay of the “Forgot-to-view Program” may be automatically started at the start time of the program attached with “Forgot-to-view” or at 19 o'clock in this case. Even if the “Forgot-to-view” mark 601 is provided to the frame of the “Related Program” as in the EPG 600 of FIG. 19(B), the replay of the “Forgot-to-view Program” may be automatically started at a time that allows continuous viewing, or 19 o'clock, if the “Forgot-to-view” is selected at an arbitrary timing before 19 o'clock. Although the program transmission/reception system shown in FIG. 30 is a modified example of the third embodiment, the replay instruction unit 191 may also be applied to the first, second, fourth, and fifth embodiments.

The “Missed-to-view” mark or the “Forgot-to-view” mark may be selected to receive the “Missed-to-view Program” or the “Forgot-to-view Program” to start recording, or the recording may be reserved.

Although the control as shown in FIG. 13 is performed in the embodiments when new EPG information transmitted from the broadcast station 100 is received, the control shown in steps S402 to S409 may be performed when an instruction for displaying the EPG is issued. The EPG can be immediately displayed when there is a display instruction of the EPG by creating the EPG information inside the program reception apparatus 200 without displaying the EPG on the display screen 147 as in FIG. 13. Obviously, the determination of not viewing the program is sequentially updated from time to time.

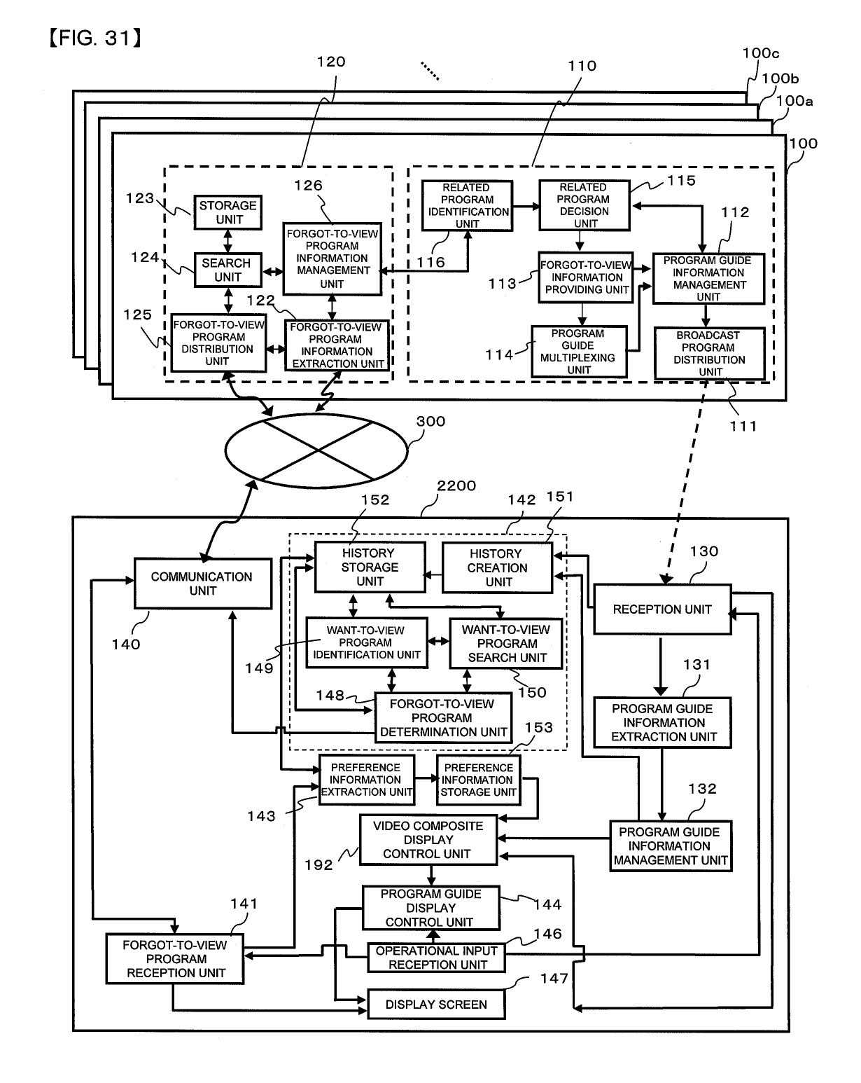

Although the “Missed-to-view” mark or the “Forgot-to-view” mark is provided to the EPG to notify the user of the existence of the “Missed-to-view Program” or the “Forgot-to-view Program” in the embodiments, the existence of the “Missed-to-view Program” or the “Forgot-to-view Program” may be multiplexed with the broadcast program or may be displayed on a screen different from the broadcast program. FIG. 31 is a diagram showing a configuration of the program transmission/reception system that multiplexes and displays the existence of the “Missed-to-view Program” or the “Forgot-to-view Program” on the broadcast program or that displays the existence on a screen different from the broadcast program and is a modified example of the configuration of FIG. 9. A program reception apparatus 2200 of the program transmission/reception system shown in FIG. 31 comprises a video composite display control unit 192 in place of the program guide display control unit 144 described in FIG. 9. The video composite display control unit 192 combines the broadcast program distributed from the broadcast program distribution unit 111 with the EPG and displays the broadcast program and the EPG. The EPG and the broadcast program are separately received in the program transmission/reception systems with the configurations shown in FIGS. 7 and 22 described in the second and fifth embodiments. Therefore, the video composite display control unit 192 combines the program guide extracted from the program guide information extraction unit 180 and the broadcast program received by the reception unit 130.

The existence of the “Forgot-to-view Program” is displayed during the broadcast of the program in the program transmission/reception system shown in FIG. 31. Therefore, instead of the instruction for displaying the EPG, the reception of the updated EPG information is used as a trigger for the execution of the control process.

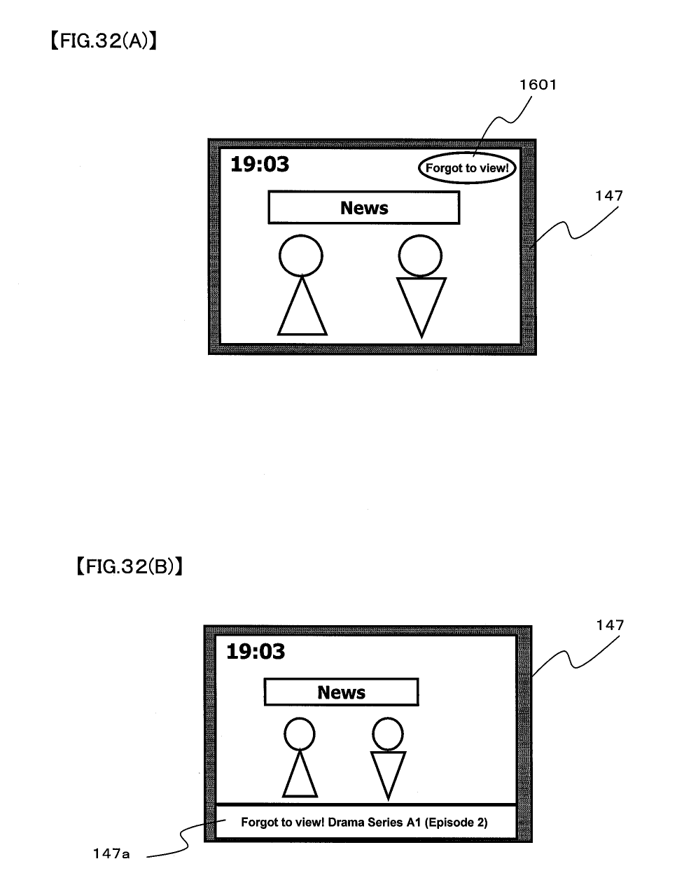

If the second episode of the drama series A1 from 20 o'clock on channel 2 is the “Forgot-to-view Program”, the third episode of the drama series A1 shown in the EPG 3000 of FIG. 3(A) is the “Related Program”. Consequently, for example, a “Forgot-to-view” mark 1601 can be multiplexed and displayed on the broadcast program as shown in the display screen 147 of FIG. 32(A) during the broadcast of the news A1 aired earlier than the “Related Program”. As shown in the display screen 147 of FIG. 32(B), “Forgot to view! Drama Series A1, Second Episode” may be described on another screen 147a below the aired program. The “Forgot-to-view” mark may be provided to display the EPG on another screen.

The configuration of FIG. 30 may also be applied to the first and second embodiments by adding the replay instruction unit to the configurations of the first and second embodiments. The configuration of FIG. 31 may also be applied to the first and second embodiments by adding the video composite display control unit to the configurations of the first and second embodiments.

Although the forgot-to-view program system unit 120 is included in the embodiments, the forgot-to-view program system unit 120 may not be included when the same broadcasts are repeated for a number of times, such as in a cable TV. In that case, a “Forgot-to-view” mark displaying information of planned rebroadcast can be provided to the “Related Program”, etc., in the EPG. When the “Forgot-to-view” mark is selected, the rebroadcast program may be displayed when the rebroadcast starts, or recording of the rebroadcast program may be reserved.

The rule for determining the “Related Programs” related to the “Forgot-to-view Program” is not limited to the rule described above (“all programs belonging to a “Want-to-view Program” group to which a “Forgot-to-view Program” belongs are identified as “Related Programs” of the “Forgot-to-view Program””). The recapitulation may be determined as a related program of a drama series, or a broadcast of fan appreciation program of Yomiuri Giants, etc., may be determined as a related program of Yomiuri Giants vs. Hanshin Tigers. The rules can be determined in advance.

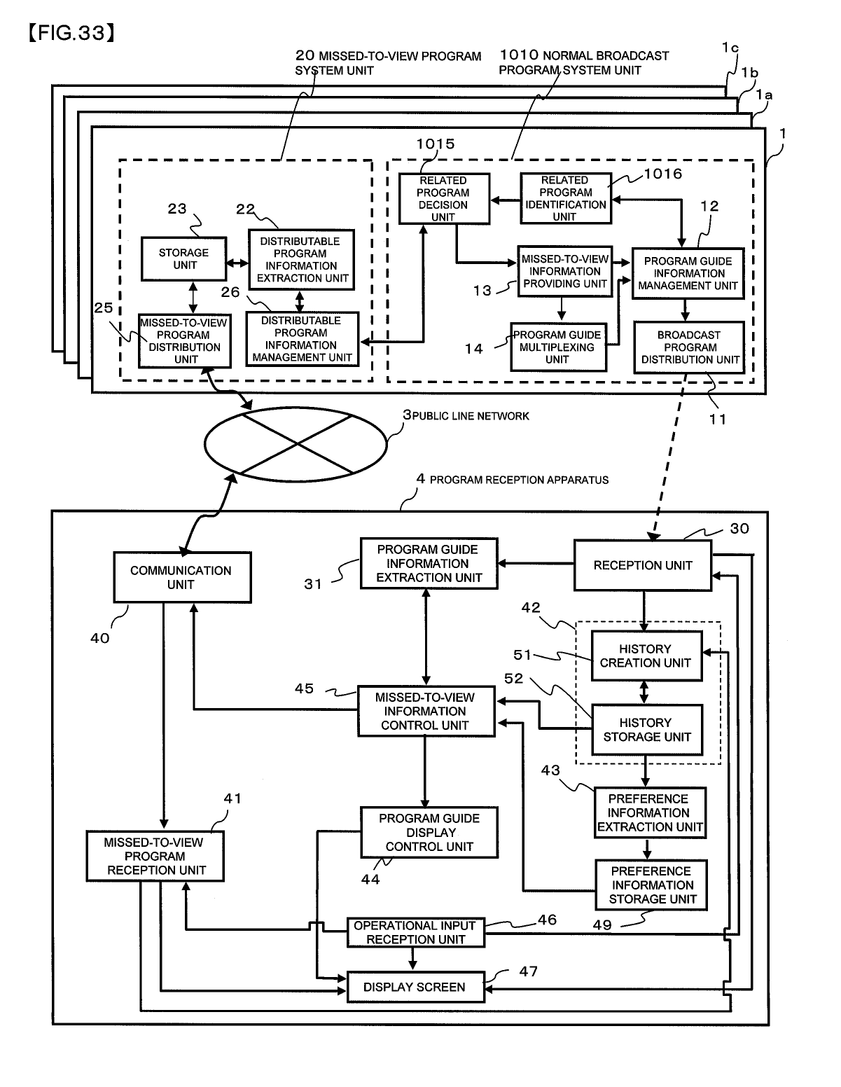

The control of identifying a “Related Program” related to “Distributable Program” which is stored in the storage unit 23, and providing the “Missed-to-view” mark to the frame of “Related Program” if the “Related Program” exists in programs of the EPG is executed in the first embodiment. Although deciding whether a program related to the “Distributable Program” exists in programs of EPG is executed in the first embodiment in this way, deciding whether a program related to each program of EPG exists in “Distributable Programs” may be executed. FIG. 33 is a figure of constitution of a program transmission/reception system of such a constitution.

A program transmission/reception system shown in FIG. 33 comprises a normal broadcast program system unit 1010 in place of the normal broadcast program system unit 10 described in FIG. 1. Compared to the normal broadcast program system unit 10, the normal broadcast program system unit 1010 comprises a related program decision unit 1015 and a related program identification unit 1016 in place of the related program decision unit 15 and the related program identification unit 16. The related program identification unit 1016 identifies a “Related Program” related to each program of EPG. The related program decision unit 1015 decides whether a “Related Program” related to each program of EPG exists among the “Distributable Programs”.

A control of the program transmission/reception system shown in FIG. 33 will be described.

The related program identification unit 1016 identifies a “Related Program” related to each program of EPG based on a predetermined rule.

The third episode of the drama series A1 in the EPG 3000 as shown in FIG. 3(A) will be described as an example. “Related Programs” related to the third episode of the drama series A1 are identified as the first episode, the second episode, and the forth episode of the drama series A1. In this case, the predetermined rule is a rule “if there is one of the episodes of a drama series in EPG, all programs of the drama series are identified as “Related Programs””.

In this way the “Related Program” is identified, and the related program decision unit 1015 compares information of the “Distributable Programs” received from the distributable program information management unit 26 with information received from the related program identification unit 1016 and decides whether the “Related Program” exists among the “Distributable Programs”. If the “Related Program” exists among the “Distributable Programs”, information of the existence is transmitted to the missed-to-view information providing unit 13. The missed-to-view information providing unit 13 provides the “Missed Viewing” mark. For example, if the first episode and the second episode of the drama series A1 exist among the “Distributable Programs”, the “Missed Viewing” mark is provided to the frame of the third episode of the drama series A1 of EPG (see FIG. 3(B)). In addition, similar processing is executed about the other programs in the EPG.

The processing of providing the “Missed Viewing” mark can be executed by the above mentioned control.

An example of the related programs according to the present invention corresponds to a program (for example the third episode of the drama series A1) which is related to “Distributable Programs” and which exists in EPG, and a program (for example the first episode, the second episode of the drama series A1) which is related to programs of EPG and which exists among the “Distributable Programs”.

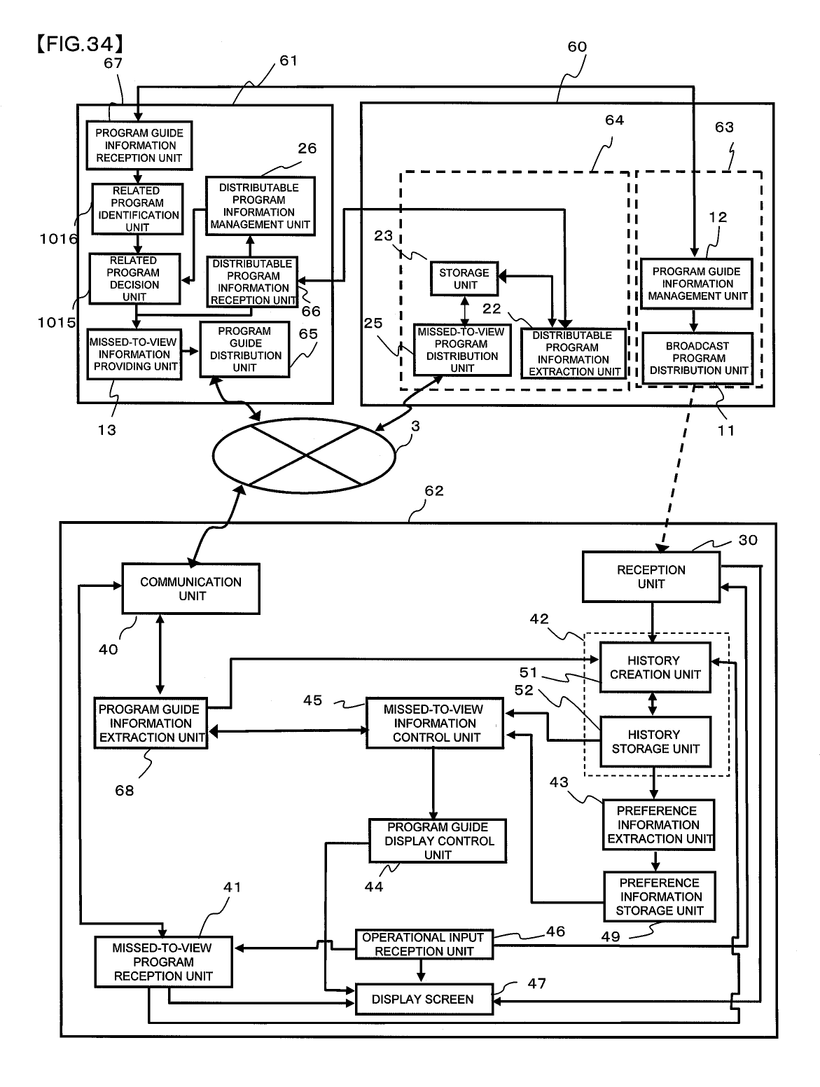

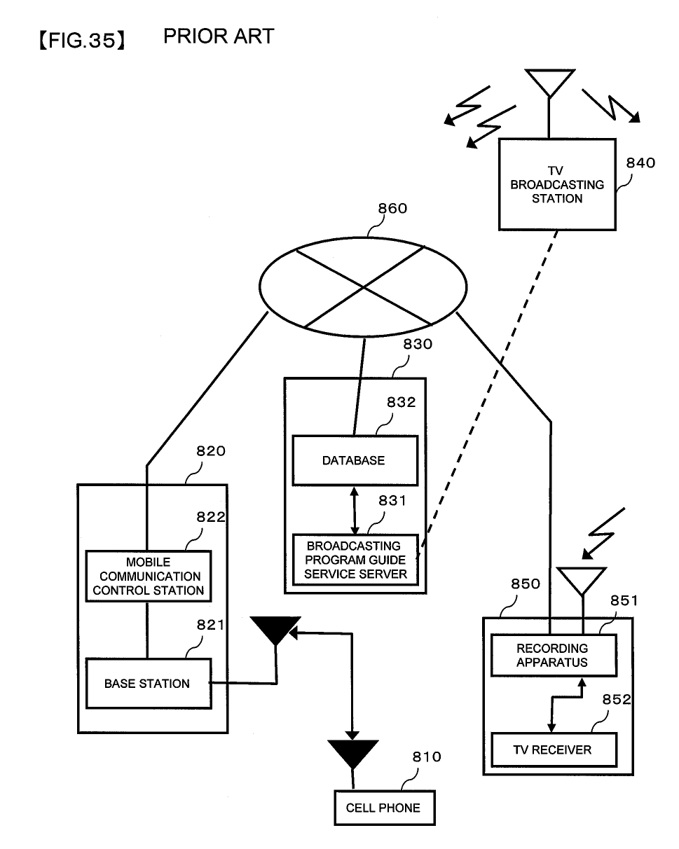

In addition, the program transmission/reception system in the second embodiment is transformed and a control like the above may be executed. A program guide distribution apparatuses 1061 of a program transmission/reception system shown FIG. 34 differs from the program guide distribution apparatuses 61 of a program transmission/reception system in the second embodiment, in comprising a related program decision unit 1015 and a related program identification unit 1016 in place of a related program decision unit 15 and related program identification unit 16. The related program identification unit 1016 identifies a “Related Program” related to each program of EPG received from program guide information reception unit 67. The related program decision unit 1015 compares information of the identified the “Related Program” with information of the “Distributable Programs” received from the distributable program information management unit 26, and decides whether the “Related Program” exists among “Distributable Programs”.

In addition, above the constitution and the control of a program transmission/reception system of FIG. 33 or FIG. 34 can apply to a program transmission and reception system of FIG. 9, FIG. 16, FIG. 17, FIG. 18, FIG. 22, FIG. 24, FIG. 30, or FIG. 31.

As described, the program guide distribution apparatus, the program distribution apparatus, and the program guide transmission/reception system according to the present invention are capable of showing the existence of the “Forgot-to-view Program” related to a not-yet-view program in the distribution system when the EPG is displayed and are useful for viewing the forgot-to-view program, etc., associated with broadcasting.

Moreover, the program guide distribution apparatus according to the present invention may consist of a CPU and an output region unit connected to CPU, and a method to realize above-mentioned operation consists of a program. The program guide distribution apparatus according to the present invention may be adopted a constitution such that an interpretation is performed and processed by the CPU.

The program according to the present invention is a program of making a computer execute the operation of each step of the program guide distribution method of the present invention mentioned above at least, and is a program which operates in collaboration with the computer.

The program according to the present invention is a program of making a computer execute the operation of each step of the program guide reception method of the present invention mentioned above at least, and is a program which operates in collaboration with the computer.

Moreover, the recording medium of the present invention is a recording medium which records a program for making a computer execute all or a part of operation of each step of the program guide distribution method of the present invention mentioned above and which is a readable by the computer, whereby the read program performs the operation in collaboration with the computer.

Moreover, the recording medium of the present invention is a recording medium which records a program for making a computer execute all or a part of operation of each step of the program guide reception method of the present invention mentioned above and which is a readable by the computer, whereby the read program performs the operations in collaboration with the computer.

In addition, the above “the operation of each step” of the present invention means all or a part of operation of the step.

Moreover, one utilizing form of the program of the present invention may be an aspect of being recorded on a recording medium, ROM and the like are included, which can be read by a computer, and operating with collaborating with the computer.

Moreover, one utilizing form of the program of the present invention may be an aspect of being transmitted inside a transmission medium, transmission media such as the Internet, light, radio waves, and acoustic waves and the like are included, being read by a computer, and operating with collaborating with the computer.

Furthermore, a computer according to the present invention described above is not limited to pure hardware such as a CPU and may be arranged to include firmware, an OS and, furthermore, peripheral devices.

Moreover, as described above, configurations of the present invention may either be realized through software or through hardware.

The program guide distribution apparatus according to the present invention have an effect that the user does not particularly have to intentionally perform searching, and the user can naturally recognize a missed-to view or a forgot-to-view program in a daily act of viewing TV broadcasting or TV guide, and is useful in a program guide distribution apparatus, a program guide distribution apparatus, a program transmission/reception system or the like.

What is claimed is:

1. A program guide distribution apparatus comprising:
a related program decision unit that compares distributable programs which were broadcasted and which can be distributed, with programs which exist in a program guide of broadcast, and decides whether programs related to each other exist;
a display information providing unit that provides a display indicative of the existence of the related program among the distributable programs to the program guide, when the related programs exist; and
a program guide information distribution unit that distributes information of the program guide.

2. A program distribution apparatus comprising:
the program guide distribution apparatus according to claim 1;
a broadcast program distribution unit that distributes a program to be broadcasted; and
a program guide multiplexing unit that multiplexes the program guide information with the program to be broadcasted, wherein
the broadcast program distribution unit also serves as the program guide information distribution unit.

3. A program distribution apparatus comprising:
the program guide distribution apparatus according to claim 1; and
a broadcast program distribution unit that distributes a program to be broadcasted, wherein
the program guide information distribution unit distributes the information of the program guide and the information of the program guide is distributed separately from the program to be broadcasted.

4. A program guide reception terminal comprising:
a program guide information reception unit that receives information of a program guide which is generated by a program guide distribution apparatus comparing distributable programs which were broadcasted and which can be distributed, with programs which exist in a program guide of broadcast, and deciding whether programs related to each other exist, and providing a display indicative of the existence of the related program among the distributable programs to the program guide when the related programs exist; and
a display information control unit that controls the display indicative of the existence of the related program among the distributable programs provided to the program guide, wherein
the display information control unit changes or deletes the display indicative of the existence of the related program among the distributable programs in the case that the distributable program is already viewed.

5. The program guide reception terminal according to claim 4, further comprising
a history creation unit that creates a viewing history based on viewed programs; and
a preference information extraction unit that extracts preference information of a viewer from the viewing history, wherein
the display information control unit changes or deletes the display indicative of the existence of the related program among the distributable programs, when the related program among the distributable programs and the preference information do not match.

6. The program guide reception terminal according to claim 5, wherein
the history creation unit creates the viewing history based on a viewing status of viewing through broadcast or network.

7. The program guide reception terminal according to claim 6, wherein
the preference information extraction unit extracts the preference information of the viewer from the viewing history created based also on a viewing status of the related program among the distributable programs.

8. A program guide transmission/reception system comprising:
a program guide distribution apparatus comprising: a related program decision unit that compares distributable programs which were broadcasted and which can be distributed, with programs which exist in a program guide of broadcast, and decides whether programs related to each other exist; a display information providing unit that provides a display indicative of the existence of the related program among the distributable programs to the program guide, when the related programs exist; and a program guide information distribution unit that distributes information of the program guide; and
a program guide reception terminal comprising: a program guide information reception unit that receives the information of the program guide; and a display information control unit that controls the display indicative of the existence of the related program among the distributable programs provided to the program guide, wherein the display information control unit changes or deletes the display indicative of the existence of the related program among the distributable programs in the case that the distributable program is already viewed.

9. The program guide distribution apparatus according to claim 1, wherein
the related program is a program continuous with the distributable program, a program with the same cast as the distributable program, or a program of the same genre as the distributable program.

10. The program guide distribution apparatus according to claim 1, wherein
the display information providing unit provides the display indicative of the existence of the related program among the distributable programs to a frame of one of a plurality of program fields of the channel to which the related program belongs.

11. The program guide distribution apparatus according to claim 1, wherein
the display information providing unit provides the display indicative of the existence of the related program among the distributable programs to a time display field.

12. A program guide distribution method comprising:
a related program decision step of comparing distributable programs which were broadcasted and which can be distributed, with programs which exist in a program guide of broadcast, and deciding whether programs related to each other exist;
a display information providing step of providing a display indicative of the existence of the related program among the distributable programs to the program guide, when the related programs exist; and
a program guide information distribution step of distributing information of the program guide.

13. A program guide reception method comprising:
a program guide information reception step of receiving information of a program guide which is generated by a program guide distribution method comparing distributable programs which were broadcasted and which can be distributed, with programs which exist in a program guide of broadcast, and deciding whether programs related to each other exist, and providing a display indicative of the existence of the related program among the distributable programs to the program guide when the related programs exist; and
a display information control step of controlling the display indicative of the existence of the related program among the distributable programs provided to the program guide, wherein
the display related to the distributable program is changed or deleted in the display indicative of the existence of the related program among the distributable programs in the case that the distributable program is already viewed.

14. A non-transitory computer-readable medium having a program stored thereon for causing a computer to execute the program guide distribution method according to claim 12.

15. A non-transitory computer-readable medium having a program stored thereon for causing a computer to execute the program guide reception method according to claim 13.
